(19) United States
(12) Patent Application Publication
(10) Pub. No.: US 2021/0110474 A1
(43) Pub. Date: Apr. 15, 2021

(54) Blockchain-Based Method, Apparatus, and System to Accelerate Transaction Processing

(71) Applicant: 9th Gear Technologies, Inc., Palo Alto, CA (US)

(72) Inventors: Maryanne Morrow, Foster City, CA (US); Katherine Maher, Wellesley Hills, MA (US); Andrew Fately, Basking Ridge, NJ (US); Jay Payne, San Antonio, TX (US); Wyatt Barnes, San Antonio, TX (US); John Gillespie, Palo Alto, CA (US)

(73) Assignee: 9th Gear Technologies, Inc., Palo Alto, CA (US)

(21) Appl. No.: 17/129,166

(22) Filed: Dec. 21, 2020

Related U.S. Application Data
(63) Continuation of application No. PCT/US2019/038550, filed on Jun. 21, 2019.
Application No. PCT/US2019/038550 is a continuation-in-part of application No. PCT/US2019/038551, filed on Jun. 21, 2019.
Application No. PCT/US2019/038551 is a continuation-in-part of application No. PCT/US2019/038552, filed on Jun. 21, 2019.
(60) Provisional application No. 62/687,805, filed on Jun. 21, 2018.
(60) Provisional application No. 62/803,158, filed on Feb. 8, 2019.
(60) Provisional application No. 62/687,805, filed on Jun. 21, 2018.
(60) Provisional application No. 62/818,640, filed on Mar. 14, 2019.
(60) Provisional application No. 62/803,158, filed on Feb. 8, 2019.
(60) Provisional application No. 62/687,805, filed on Jun. 21, 2018.
(60) Provisional application No. 62/818,640, filed on Mar. 14, 2019.
(60) Provisional application No. 62/803,158, filed on Feb. 8, 2019.
(60) Provisional application No. 62/687,805, filed on Jun. 21, 2018.

(51) Int. Cl. G06Q 40/04; G06Q 20/38; G06Q 20/02; G06Q 20/06; H04L 9/14

(52) U.S. Cl. CPC G06Q 40/04; G06Q 20/381; G06Q 20/02; G06Q 2220/00; H04L 9/14; G06Q 20/3829; G06Q 20/3823; G06Q 20/06

(57) ABSTRACT

Blockchain, or distributed ledger network technology, facilitates and accelerates foreign currency (FX) transactions and makes them reliable and trusted by prequalifying participants in the transactions to participate. Prequalifying participants enables funding of the transaction before parties enter into a trade, reducing the time required to consummate a transaction. In one aspect, the credit aspect of these transactions is disaggregated from the transactions themselves, eliminating credit risk and delivery risk, among others. Immutability of data in the blockchain enhances transaction reliability, and promotes confidence on both sides of a given transaction. In another aspect, fully collateralized fiat coins (FCFC) residing within the blockchain are based on an underlying fiat currency. Within the blockchain, the FCFC are their own currency.

### CROSS-REFERENCE TO RELATED APPLICATIONS

The present application is a continuation-in-part of International Application Numbers PCT/US2019/038550, PCT/US2019/038551, and PCT/US2019/038552, all filed Jun. 21, 2019. Each of these international applications claims priority from U.S. Provisional Patent Application Nos. 62/687,805, filed Jun. 21, 2018; 62/803,158, filed Feb. 8, 2019; and 62/818,640, filed Mar. 14, 2019. The present application incorporates by reference herein the entirety of all of the just-mentioned applications.

### FIELD OF THE INVENTION

The present invention relates to distributed ledger applications, particularly blockchain applications, and more particularly to blockchain applications to cut dramatically the amount of time needed to consummate transactions, particularly financial transactions, more particularly foreign currency (FX) transactions.

### BACKGROUND OF THE INVENTION

Distributed ledger technology, one version of which is blockchain, has been in existence for some years now. Among other attributes, blockchain facilitates trustless transactions by providing immutable recording of transactions in a ledger that is distributed among a plurality of nodes constituting the blockchain.

It would be desirable to provide this trustless environment to facilitate financial transactions, so as to reduce dramatically the amount of time needed to consummate a particular transaction, and to enable the consummation of numerous such transactions per day.

### SUMMARY OF THE INVENTION

In one aspect, the present invention provides on-demand payment liquidity for foreign currency (FX) transaction—using blockchain, or distributed ledger network, technology. Embodiments enable on-demand payment liquidity according to a “fund then trade” model.

The system described herein enables the separation of the purely financial considerations of a given financial transaction—for example, the buying and/or selling of foreign currency—from the risk attendant to funding such a transaction, on the part of any party to the transaction. In one aspect, such a transaction will involve a currency buyer and a currency seller, as will be described in more detail herein. In one aspect, a lending entity may participate in the transaction by lending funds to either the buyer or the seller so that the transaction is fully funded. Different lending entities may lend funds to the buyer and the seller, respectively.

In another aspect, embodiments provide for the use of tokens, having value equal to their underlying fiat currency to effect transactions. The tokens are fully collateralized, so that their value fluctuates versus other currencies only as their underlying fiat currency fluctuates versus other currencies. The inventors have termed such tokens as fully collateralized fiat cogs or fiat coins (FCFC).

In accordance with aspects of the invention, a system effects accelerated foreign exchange (FX) transaction processing, the system including apparatus to effect the following:
responsive to a first indication from a first party of a desire to enter into a FX transaction, record the first indication in encrypted fashion in the system, and provide a first approval to the first party to engage in the FX transaction in response to satisfaction of first predetermined criteria which are communicated in encrypted fashion within the system; and
responsive to a second indication from a second party of a desire to enter into the FX transaction, record the second indication in encrypted fashion in the system, and provide a second approval to the second party to engage in the FX transaction in response to satisfaction of second predetermined criteria which are communicated in encrypted fashion within the system; and
record, in encrypted and immutable fashion, steps to effect the FX transaction; wherein the system further comprises:
a first user interface (UI) and a first application programming interface (API) to enable the first party to communicate with the system;
a second UI and a second API to enable the second party to communicate with the system;
at least one state machine to manage the FX transaction in response to actions of the first party and the second party;
the first party to participate in the FX transaction by exchanging first tokens that are priced according to a first fiat currency, for second tokens that are priced according to a second fiat currency; and
the second party to participate in the FX transaction by exchanging the second tokens that are priced according to the second fiat currency, for the first tokens that are priced according to the first fiat currency;
wherein a value of the first tokens fluctuates only according to fluctuations in an underlying value of the first fiat currency, and a value of the second tokens fluctuates only according to fluctuations in an underlying value of the second fiat currency.

The state machine may include apparatus to freeze or unfreeze funds of the first party or the second party sufficient to effect the FX transaction.

Apparatus may be provided to execute at least one smart contract, responsive to the satisfaction of the first and second predetermined criteria, to effect the FX transaction.

Apparatus may be provided to disaggregate funding of an FX transaction from the FX transaction itself by prequalifying the funding in a secure and trusted manner.

At least one of the first and second predetermined criteria may include agreement from at least one lender to provide funds in one of the first and second fiat currencies to one of the first party and the second party to prequalify one of the first party and the second party to engage in the FX transaction. A third UI and a third API may be provided to enable the at least one lender to provide at least some of the first tokens to the first party, or at least some of the second tokens to the second party.

The first predetermined criteria may include agreement from multiple lenders to provide a first required amount of funds in the first fiat currency, as at least some of the first tokens, to the first party to prequalify funding for the first party to engage in the FX transaction. The first required amount of funds may consist of all of the funds that the first party will use to engage in the FX transaction.

The second predetermined criteria may include agreement from multiple lenders to provide a second required amount of funds in the second fiat currency, as at least some of the second tokens, to the second party to prequalify funding for the second party to engage in the FX transaction. The second required amount of funds may consist of all of the funds that the second party will use to engage in the FX transaction.

The system may include a blockchain-on which the FX transaction is conducted, and/or an oracle to communicate data regarding the FX transaction with the blockchain, and/or a security system to provide encryption for the first and second predetermined criteria, and to enable encrypted recording of the steps of the FX transaction. The security system may include a key management server to manage private encryption keys, and a hardware security module to generate the private encryption keys to provide the encryption for the first and second predetermined criteria, and to enable encrypted recording of the steps of the FX transaction.

In accordance with aspects of the invention, a method to effect accelerated foreign exchange (FX) transaction processing carries out the following:
responsive to a first indication from a first party of a desire to enter into a FX transaction, recording the first indication in encrypted fashion, and providing a first approval to the first party to engage in the FX transaction in response to satisfaction of first predetermined criteria which are communicated in encrypted fashion; and responsive to a second indication from a second party of a desire to enter into the FX transaction, recording the second indication in encrypted fashion, and providing a second approval to the second party to engage in the FX transaction in response to satisfaction of second predetermined criteria which are communicated in encrypted fashion; and
recording, in encrypted and immutable fashion, steps to effect the FX transaction; the method further comprising:
managing the FX transaction in response to actions of the first party and the second party;
the first party to participate in the FX transaction by exchanging first tokens that are priced according to a first fiat currency, for second tokens that are priced according to a second fiat currency; and
the second party to participate in the FX transaction by exchanging the second tokens that are priced according to the second fiat currency, for the first tokens that are priced according to the first fiat currency;
wherein a value of the first tokens fluctuates only according to fluctuations in an underlying value of the first fiat currency, and a value of the second tokens fluctuates only according to fluctuations in an underlying value of the second fiat currency.

Funds of the first party or the second party sufficient to effect the FX transaction may be frozen or unfrozen.

At least one smart contract may be executed, responsive to the satisfaction of the first and second predetermined criteria, to effect the FX transaction.

Funding of an FX transaction may be disaggregated from the FX transaction itself by prequalifying the funding in a secure and trusted manner.

At least one of the first and second predetermined criteria may include agreement from at least one lender to provide funds in one of the first and second fiat currencies to one of the first party and the second party to prequalify one of the first party and the second party to engage in the FX transaction, the at least one lender to provide at least some of the first tokens to the first party, or at least some of the second tokens to the second party.

The FX transaction may be conducted in a blockchain system. Data regarding the FX transaction may be communicated with the blockchain system. Encryption may be provided for the first and second predetermined criteria, and encrypted recording of the steps of the FX transaction enabled.

Private encryption keys may be managed on a key management server, and the private encryption keys generated to provide the encryption for the first and second predetermined criteria, and to enable encrypted recording of the steps of the FX transaction, on a hardware security module.

### BRIEF DESCRIPTION OF THE DRAWINGS

Embodiments of the invention now will be described in detail with reference to the accompanying drawings, in which:

FIG. 1 is a high-level system architecture diagram according to embodiments;

FIG. 2 is another high-level system architecture diagram according to embodiments;

FIG. 3 is a state diagram according to embodiments;

FIG. 4 is another state diagram according to embodiments;

FIG. 5 is yet another state diagram according to embodiments;

FIG. 6 is a flow chart depicting a taker's side of an exemplary transaction according to an embodiment;

FIG. 7 is a flow chart depicting a maker's side of an exemplary transaction according to an embodiment;

FIG. 8 is a flow chart depicting a lender's role in an exemplary transaction according to an embodiment;

FIG. 9 is a high level diagram depicting transaction flow with FCFC according to an embodiment;

FIG. 10 is a diagram depicting creation of FCFC according to an embodiment;

FIG. 11 is a diagram depicting an FX transaction employing FCFC according to an embodiment;

FIG. 12 is a diagram depicting payment of interest on FX transactions employing FCFC according to an embodiment;

FIG. 13 is a diagram depicting redemption of FCFC in FX transactions employing FCFC according to an embodiment;

FIG. 14 is a diagram depicting an FX transaction involving borrowing/lending according to an embodiment;

FIG. 15 is a diagram depicting a payment from one entity to another according to an embodiment;

FIG. 16 is a diagram depicting an exemplary lending transaction according to an embodiment;

FIG. 17 is a diagram of a blockchain with various nodes, and a buying/selling/lending transaction among entities on three of those nodes according to an embodiment;

FIGS. 18A and 18B are high level diagrams of a private distributed ledger providing data privacy according to an embodiment;

FIG. 19 is a block diagram of a private distributed ledger providing data privacy and supporting smart contracts according to an embodiment;

FIG. 20 is a block diagram of an embodiment of a distributed ledger system;

FIG. 21 is a block diagram of an embodiment of a taker portion of a distributed ledger system;

FIG. 22 is a block diagram of an embodiment of a maker portion of a distributed ledger system;

FIG. 23 is a block diagram of an embodiment of a lender portion of a distributed ledger system;

FIG. 24 is a high level diagram of portions of a private contract according to an embodiment;

FIG. 25 is a high level diagram of a database according to an embodiment;

FIG. 26 is a high-level system architecture diagram according to embodiments;

FIG. 27 is another high-level system architecture diagram according to embodiments.

### DETAILED DESCRIPTION

As ordinarily skilled artisans will appreciate, the following describes a practical application of blockchain technology, employing secure discrete hardware modules for handling of private keys, to effect various kinds of financial transactions involving securities, currencies, real property, and other assets in a secure and verifiable manner. Without this technology, the whole concept of credit risk and delivery risk could continue to prevail. The inventors have found it significant that foreign exchange transactions have been carried out the same way for so long. A trade is initiated at date T, but is not consummated until day T+2 because of the credit risk and delivery risk inherent in the transaction. Developing a blockchain-based system removed concern about these risks by creating and retaining verifiable and immutable records of the various steps of the transactions. Without this technology, two parties in the same building, or even the same room, and engaging in a transaction would be unable to confirm and verify that the transaction should go through.

Before proceeding to details of embodiments disclosed herein, following is a very high level discussion of some aspects of the inventive system, along with certain terminology.

The term “blockchain” has been in existence for a sufficient length of time to have a meaning that is understood by ordinarily skilled artisans. Without intending to limit the definition of blockchain here, but to facilitate an understanding of the concepts presented herein, at its most fundamental level, blockchain is a cryptographic ledger of transactions. That cryptographic ledger is distributed to nodes in the blockchain.

There are different categories of blockchains. A blockchain may be public; it may be private; it may be permissioned; or it may be private and permissioned. Ordinarily skilled artisans understand these terms, so detailed definitions are not provided herein.

A public blockchain is a blockchain which anyone in general may join and participate in the activities of the blockchain. The public is free to join, or leave, or read, or write, or audit the ongoing activities.

A private blockchain is a blockchain which users may join by invitation. Thus, one distinction between a public blockchain and a private blockchain is that a private blockchain has control over who is allowed to participate in the blockchain.

A permissioned blockchain is a blockchain which has restrictions on who may join, and what participants may do. A permissioned blockchain may be considered to be one type of private blockchain, but the art contains references to private permissioned blockchains, in which both access and activity may be restricted.

Between the use of cryptography and the distribution of the ledger, the likelihood of hacking the blockchain to disrupt, reorder, or otherwise alter any of the nodes in the blockchain becomes extremely low. This low probability exists, at least in part, because the ledger of transactions does not reside only with a single third party, but instead resides in the nodes in the blockchain. The nodes operate according to a consensus mechanism to ratify transactions. With some consensus mechanisms, such as Istanbul Byzantine Fault Tolerant (IBFT), participants arrive at a mutual agreement. A blockchain operating with IBFT can continue to function properly even if some nodes are dishonest. With other consensus mechanisms, such as RAFT, participants trust a leader. Not surprisingly, because there is no need for agreement among participants, RAFT tends to work faster than IBFT. In a private permissioned blockchain, it can tend to be less likely that participants will take over, because participants are there by invitation and have their activities circumscribed.

A blockchain generally does not have a way of accessing information outside of itself. Such a restriction is important for the integrity of transactions on the blockchain. In order for the blockchain to acquire information, the blockchain needs a trusted external source. An oracle is an example of such a trusted external source, functioning outside the blockchain, that supplies data to the blockchain. In general, an oracle finds and verifies data and transmits that data to the blockchain. In one context, an oracle may be thought of as a layer that interfaces with both data sources and with the blockchain. In this sense, an oracle transfers and translates data from outside the blockchain, onto the blockchain. According to embodiments, there may be multiple oracles providing data to the blockchain.

A blockchain may contain pieces of self-executing code known as smart contracts. Smart contracts may be self-executing in that, in response to receipt of certain data, certain functions may be carried out. For example, in the case of an FX transaction, a smart contract may contain code regarding conditions for funding of the transaction. When the smart contract receives inputs indicating that those conditions are met, the smart contract may allow the transaction to proceed. In one aspect, those inputs come from the one or more oracles. According to embodiments, for a given FX transaction, there may be multiple smart contracts that execute.

Generally speaking, oracles generally coordinate transaction portions which are to be carried out outside of the blockchain (off chain). For example, the matching of a taker (a party seeking to initiate a transaction) and a maker (a party seeking to participate in the transaction with the taker) may occur off chain. In a situation in which a taker, or a maker, or both, lacks funds to complete the transaction, identification and selection of one or more lenders to enable funding of the transaction prior to its execution also may occur off chain. In one aspect, oracles will contain logic for handling and routing of information, and will provide an interface between involved financial institutions and the blockchain.

In one aspect, one or more of the oracles in the system described herein may incorporate machine learning, in the form of a neural network or other machine learning structure. The nature and volume of financial transactions that will be carried out will produce a substantial amount of non-user specific data which can be mined to obtain insights into when and how transactions are carried out, including not only such things as timing and periodicity of different types of transactions, but also quantities of transactions.

In one aspect, the blockchain disclosed herein may be a private permissioned blockchain, operating with a RAFT consensus mechanism. According to the RAFT consensus mechanism, every node within the network may have a copy of the blockchain in un-encrypted form. The only delineation between the RAFT leader and RAFT followers is that the RAFT leader decides what transaction are considered valid, collects valid transactions into a block, then adds the block to the chain. When the RAFT leader announces the next block in the chain, all the followers will simply add the new block to their copies of the chain, without doing any additional work such as verifying the transactions within the new block. Accordingly, every node, follower or leader, may have direct access to the entire, unencrypted blockchain, including access to all of the transactions which have occurred.

With the foregoing approach, if direct access to the blockchain is to be limited, that may be accomplished in the following way. A blockchain may exist within a virtual private cloud (VPC), meaning that only authorized systems will have direct access to the nodes within the blockchain network. All nodes will contain a blockchain of all transactions that have taken place, so that any node can be queried in order to obtain details on any transaction. Users of such a system (in an FX transaction conducted according to aspects of the present invention, a taker, a maker, or a lender) may receive specific details only of transactions to which they are specifically permitted access. For example, the system may maintain a record of transactions in which any particular user participated. The system then can reach out to the oracle to query details about any particular transaction (e.g. currencies traded, currency amounts, etc.) from any of the blockchain nodes, and can return specific details about that transaction to the UIs to for display to the user.

In one aspect, in a private permissioned blockchain, operating with a RAFT consensus mechanism, the leader may be the only one with direct access to the blockchain, and the only one with a copy of the blockchain. Irrespective of whether a system participant was part of a transaction, that participant will have a copy. Instead, the leader may provide specific transaction details to appropriate parties regarding any particular transaction. Consequently, parties to a particular transaction, and other entities (if any) which are entitled to see the transaction, will be able to see transaction details, for which they will have copies. Other entities on the blockchain, which are not entitled to see details of the transaction, will have copies of the transaction as well, but only in encrypted form, for example, as a cryptographic hash. In one aspect, because a cryptographic hash is a unique representation of data, the stored cryptographic hash at each node that is not entitled to see details of the transaction can be compared readily to the transaction details to verify the accuracy of the details. As far as the consensus protocol for verifying that the transaction has taken place, the hash will provide that necessary verification. Receipt of that hash at the nodes will enable provision of that consensus.

According to an embodiment, when a given transaction executes on the inventive system, assets are exchanged. For example, for a foreign exchange transaction, a taker might want to purchase euros with dollars. A maker who enters into the transaction will provide euros in exchange for dollars. At the beginning of the transaction, the taker may want to buy euros with dollars. The maker may have euros to sell in exchange for dollars. In an embodiment, tokens signifying those currencies may be minted when each party deposits its respective fiat currency into a custodian bank. In another aspect, if the taker has sufficient dollars to engage in the desired transaction, tokens signifying those dollars will be minted within the blockchain. Likewise, if the maker has sufficient euros to engage in the desired transaction, tokens signifying those euros also will be minted. When there is sufficient indication that the taker and the maker have sufficient funds, the tokens may be exchanged on the blockchain, signifying consummation of the transaction. In one aspect, tokens may be transferred between accounts on the blockchain, and may persist, being effectively debited from one account and credited to another. Crediting and debiting them between accounts prevents double spending of assets. The tokens remain until a participant decides to “redeem” tokens and withdraw currency from a custodian bank, at which point the tokens will be burned. In another aspect, the tokens are not persistent. In this other aspect, once the transaction is complete, that is, when both parties to the transaction confirm receipt of their respective funds, the tokens are disposed of, or burned. Burning the tokens is one way of avoiding double spending of assets. When the transaction is complete, the taker will have euros, and the maker will have dollars.

According to aspects of the invention, the exchange of tokens can occur with respect to any transaction to which a maker and a taker may be parties. Typically such a transaction involves electronic exchange of financial assets between accounts. As will be discussed herein by way of example, aspects of the present invention are applicable to the foreign exchange (FX) market. The assets could be different currencies.

In addition, as alluded to earlier, some of the following discussion describes what the inventors have termed a fully collateralized fiat coin (FCFC). There are various names, known to ordinarily skilled artisans, for the digital information that gets exchanged in a distributed ledger technology system such as blockchain, and that signifies or denotes currency. Importantly, FCFC exists solely within the blockchain. According to some embodiments, FCFC exists more particularly within a private permissioned blockchain. There is no opportunity to mine or trade in FCFC outside of the private permissioned blockchain within which the FCFC resides. In fact, as will be discussed, for some market participants there may be advantages in allowing the FCFC to remain, for further subsequent use. For example, overnight interest rates that custodian banks may pay, may be attractive to the holders of the FCFC.

Accordingly, in an embodiment, the FCFC may be persistent, and may not be disposed of once the transaction is complete. Because the blockchain environment in which embodiments of the invention operate is private and permissioned, the environment is closed. As a result, while FCFC may be burned when a participant withdraws and the custodian bank is sent a message to wire funds to the participant, FCFC otherwise do not leave the blockchain. They are not “mined” or exchanged in any way that would vary their value. Instead, FCFC retain their value, corresponding to the fiat currency in which the FCFC were issued, within the closed system. As a result, the FCFC may persist.

In the following, an FX transaction may be referred to as a trade in which two parties exchange currencies—for example, dollars (USD) for euros (EUR), or pounds sterling (GBP) for yen (JPY). When referring to exchanges between buyers and sellers, the terms trade and transaction may be used interchangeably. Presently, the four just-mentioned currencies, plus Canadian dollars (CAD) and Australian dollars (AUD), constitute the great majority of foreign currencies being traded in the FX market. There are restrictions on trading of a number of currencies, including Chinese yuan (RMB), and Korean won (KRW), among others. These restrictions per se are not relevant to the present invention. As or if such restrictions are lifted, trading in these currencies using the technology provided by the present invention will be equally beneficial.

Looking at aspects of the present invention in another way, one important aspect of a system to implement same day trading and settlement of foreign exchange transactions relates to the payment process (sometimes referred to as payment rails) necessary to move funds in real time between and among parties to a given transaction. These parties may include a lender, a taker, and a maker. The lender can provide on-demand payment liquidity to either the maker or the taker, who may be active traders, but who may not maintain the funds necessary to enable payment for each transaction in real time. Different lenders may service different makers and takers in a similar fashion. According to aspects of the invention, the presence and participation of a lender makes it possible to verify that a particular transaction is fully funded. Such verification (validation of a transaction) matters because each party can then confirm that the other is able to settle its end of the transaction immediately.

In accordance with aspects of the present invention, the following actions may take place during a given transaction (here, a foreign exchange (FX) transaction is provided as an example). First, a lender may provide funding to a customer (either the buyer or the seller in the transaction) at a spread (within a range) above a riskless benchmark rate, for example, the US Treasury Bill (T-Bill) rate. Second, the customer (again, either the buyer or the seller) may provide the provided funding as cash collateral and be paid a return, for example, the T-Bill rate. Because the participants to the FX transaction secure funding before consummating the transaction, the transaction is riskless, enabling the customer to eliminate the credit spread in the FX component of the overall transaction. As a result, the credit is disaggregated from the transaction itself.

One effect of this disaggregation is elimination of delivery risk. Addressing that risk has been part of what has made the consummation of FX transactions take so long. Elimination of delivery risk entails some or all of the following considerations. First, the lack of a common banking day globally means that payments may need to be made a day early while waiting for receipt of funds from a later time zone. For example, the taker and maker may be in different time zones, often on opposite sides of the international date line. In accordance with an aspect of the present invention, there is simultaneous or nearly simultaneous (with seconds to minutes, perhaps a few hours) settlement of both sides of the transaction on the trade date, thus eliminating delivery risk. The short time to settlement means that takers and makers get their funds much more quickly, and consequently can engage in many transactions in a given day. As a result, there is the additional benefit of increasing the velocity of settlement and hence the liquidity available in the market. Thus, by disaggregating the lending aspect of FX trades from the trades themselves, aspects of the invention assure that the trades are fully funded at the time that they are executed. As a result, there is a greatly reduced need for makers to carry enormous amounts of capital on their books.

In addition, FX trading in accordance with aspects of the invention mitigates four of the key risks which the Office of the Comptroller of the Currency (OCC) tracks. A first of these risks is credit risk. In accordance with aspects of the invention, trading is executed on a “fund then trade” basis. All trades are fully cash collateralized, thereby mitigating credit risk. A second risk is liquidity risk. With the disaggregation of the lending within an FX trade in accordance with aspects of the invention, new lenders can come into the business, serving as incremental liquidity providers to the marketplace.

A third risk is price risk. With disaggregation of lending from the rest of the transaction, the maker transacts a spot FX transaction only. Consequently, what otherwise would be an the open forward position in traditional trading is eliminated. There are several benefits to this disaggregation, in the context of operational risk. First, in the inventive system, there is immediate and immutable trade confirmation, eliminating the need for the traditional trade confirmation process that still does not fully employ straight-through processing (STP), a technique that financial institutions use to reduce settlement time by reducing human intervention and avoiding the need to re-enter certain types of data multiple times. Second, delivery risk is eliminated because payments are no longer limited by inconsistent banking hours around the world (e.g., JPY being paid a day before USD are received). Third, trade failures decline substantially with the use of “smart contracts,” code which self-executes on receipt of appropriate data, as discussed earlier. Fourth, operating costs are lower because of messaging/SWIFT (Society for Worldwide Interbank Financial Telecommunication) costs, bank wire transfer fees, and lower staff costs through more efficient processes.

In accordance with aspects of the invention, there is a system to disaggregate the credit function from the transaction, and offer a brand new and unique entry into previously inaccessible markets, such as FX and interest rate derivatives.

In accordance with aspects of the present invention, another way of looking at blockchain is as a peer-to-peer network, enabling payments directly between counterparties, and obviating the need for a central clearinghouse. This kind of arrangement requires and enables payments to be made outside of normal business hours; the immutability of data stored on the blockchain in accordance with aspects of the present invention yields lower risk and much more efficient operation compared with the current framework.

Instructions passed via the blockchain, or distributed ledger network, in accordance with aspects of the present invention will have the dual benefit of being pre-confirmed for funding and being unable to be changed because of the immutability inherent in blockchain technology, thus preventing double utilization of funds.

Conducting transactions via a private, permissioned blockchain network in accordance with aspects of the present invention will engender substantially immediate payment by both parties (taker and maker) once they agree on a price. Both parties will have to be funded, either on their own or via a participating lender. Therefore, prior to showing a deal-eligible quote, both parties will have to demonstrate, via the blockchain, that they have the requisite currencies to deliver. Establishment of adequate funding is one aspect of what enables smart contracts to self-execute.

Use of peer-to-peer payments in accordance with aspects of the present invention means that all trades, for example FX trades, will be prefunded rather than funded after the fact, a radical departure from current practice, in which a significant portion of FX transactions are being executed as naked short sales. In a naked short sale, the seller does not have the currency to deliver, whether dollars or a foreign currency, when the transaction is executed. The seller has to obtain the currency, and the buyer needs proof that the seller has done so. The resulting lack of trust (delivery risk) engendered the lengthy timeline to fund transactions.

In contrast, in accordance with aspects of the present invention, naked short sales will not occur, because in the “fund then trade” model which aspects of the present invention provide, all transactions will require confirmation that the funds are already available for delivery by the relevant counterparty before being allowed to complete. This prefunding thus essentially eliminates credit/delivery risk for spot transactions. If an entity does not have the funds available in its account, that entity will need to borrow the funds in order to engage in transactions. Otherwise the smart contracts associated with the transaction will not execute, and no trade will occur.

The result for spot transactions is twofold. First, credit risk will be extremely short term, because of prefunding and very prompt consummation of transactions. Second, with such short terms, the same funds can be re-lent multiple times during a given day. Forward transactions will require a longer commitment by the lender, as when terms are agreed, a smart contract will be created and the funds will be delivered to a third-party custodian to be segregated until the delivery date. At delivery date, the smart contract overseeing the transaction will activate the delivery, and the deal will be completed. The borrower will repay any loans directly to the lender. In one aspect, the repayment occurs on the blockchain. In another aspect, the repayment occurs outside of the blockchain.

According to embodiments of the invention, the process flow proceeds with certain assumptions. For example, lending firms may perform their own credit analysis on borrowers, and may assign credit limits. Alternatively or in addition, lending firms may provide their list of borrowers and respective limits to the lending platform. In addition, loans may be auto-approved if there is a sufficiently high limit to cover the borrowing for whatever the lending period happens to be.

A borrower (a taker or a maker) may begin a trading process by acquiring and/or validating funding. The borrower may borrow the entire amount, or a portion thereof if some of the funding is on deposit. Borrowing information may include term (start/value date and maturity date), as well as interest rate. Depending on the type of transaction or the lender's or borrower's preferences, the currency which the borrower is borrowing also may be specified. The borrower may be shown the lenders who have agreed to lend to the borrower, and who have the ability to lend to the borrower (e.g. the limit for the lender is sufficient for the amount requested, and for the term of the loan).

The borrower can accept an offer of a loan, at which point a borrowing record may be created. Both the lender and borrower are informed that the lending (the borrowing part of the buyer's or the seller's transaction) has occurred. The borrower may be informed that the loan is accepted. The lender may receive a message, or alternatively may be able to view new loan opportunities directly on the platform.

Upon completion of a borrowing transaction, the funds may be secured from the lender account for the counterparty that is due the funds. The borrower may also secure funding for part of the transaction, in which case the funds can come both from the borrower directly and from the counterparty that is due the funds. In one aspect, it may be possible, for example in the case of particularly large trades, for a borrower to borrow from more than one lender. Multiple lenders may wish to participate in such a transaction, and limits for individual lenders may not be high enough to cover the particular transaction. It may be more efficient for the borrower to receive the proceeds from one or all of the lenders, and provide all of the funds for the transaction at once, from a single source. After all this, the transaction (in the example at hand, a foreign exchange transaction) then will be completed.

In one aspect, trades can be cancelled before the smart contract(s) associated with the trades are executed. For example, a taker can request a quote, arrange funding, and cancel prior to closing the transaction. The system can have a simple cancel function on the blockchain, and the settlement can occur off system (off the blockchain). Transaction cancellation will be discussed in more detail below. In addition, in one aspect, there may be a provision for prepayment penalties for early repayment of a loan.

In one aspect, lenders may make two types of information available. In one type of information, the lender may specify the amounts that are available for lending for each currency, and the term of any particular loan. Credit limits may be allocated by currency, term, and credit rating.

In one aspect, an overall credit limit may be extended each borrower by currency. There also may be limits by term or by currency. That is, for example, there may be one or more rates for different terms (e.g. a rate for one-day, one-week, one-month, or multiple-month terms). In addition, for example, there may be different rates and/or terms for particular currencies (e.g. lower or higher rates, and/or shorter or longer terms, for less volatile or more volatile currencies).

In one aspect, the system may support multiple currencies, along the lines just discussed, though limits and terms may be defined for a particular currency, e.g. a default currency. Other currencies may be specified as applicable for the particular limit, and outstanding loans or offers may be converted to the limit currency at the current spot exchange rate. In addition, in one aspect, if a currency for a borrowing transaction is contained in a multicurrency facility, it may not be appropriate to set that up as having a separate limit for the customer in question.

In one aspect, the lender can specify the total amount that the lender is willing to lend, by currency, to individual borrowers, or to some or all of the entire borrowing base. The borrowing base may be divided in any of a number of known ways, including but not limited to dividing the borrowing base according to income, loan term, offered interest rate, or creditworthiness (credit rating). The lender can use information about borrowers (in one aspect, generically according to risk profile, type of loan, term, currency, and the like), to devise and offer different lending rates for different amounts at different times.

Aspects of the system to be discussed herein may facilitate the matching of a taker with a maker. As part of this matching, aspects of the system may facilitate a transaction between the taker and a lender, or between the maker and a lender, or between each of the taker and the maker and respective lenders. The lender(s) would provide any necessary funds that either the taker or the maker lacks, in order for the prospective trade to be fully funded.

In one aspect, the blockchain may have a relatively small number of nodes, hosted by an admin, or leader, or master. Takers, makers, and lenders will pass through the admin/master in order to get access to the blockchain. In another aspect, the blockchain may have a plurality of nodes for takers, makers, and lenders, as well as a master node. As an example, there may be one node for each taker, maker, and lender. As another example, there could be fewer nodes than takers, or makers, or lenders. In this event, some of these participants may go through the admin/master to access the blockchain. Alternatively, ordinarily skilled artisans will appreciate that a taker in one transaction may be a maker in another. Different participants may fulfill different roles, either while accessing a single node, or while accessing the blockchain through the admin/master. Ordinarily skilled artisans will appreciate that, in a given system according to an embodiment, there may, and usually will be a plurality of takers, a plurality of makers, and a plurality of lenders. In addition, a taker to one transaction may be a maker in a subsequent transaction. A lender may interact with either a taker or a maker, or in some cases with both.

One example of a blockchain, or distributed ledger network which may be employed in accordance with aspects of the invention is Quorum, although there are others which may be suitable, as ordinarily skilled artisans will understand. As exemplary descriptions of Quorum, US Published Patent Application Nos. 2017/0289111 and 2018/0183768 are incorporated herein by reference. These published patent applications enable data privacy, as will be discussed later herein.

As ordinarily skilled artisans will appreciate, and as discussed previously, a blockchain handling transactions of the type described herein will have its nodes operate according to a consensus mechanism. RAFT will be known to ordinarily skilled artisans, and so will not be described further here. IBFT is one of a family of consensus mechanisms known as Byzantine Fault Tolerant, or BFT, mechanisms. Ordinarily skilled artisans likewise have understandings of BFT, IBFT, and the like, and so those descriptions will not be repeated here. Quorum operates with either an IBFT or a RAFT consensus mechanism. In an embodiment, the blockchain architecture is Quorum, with the RAFT consensus mechanism.

RAFT is a more centralized consensus mechanism than IBFT. In some implementations, such as embodiments described herein having an operations UI and an admin UI to manage and administer some aspects of the operation, control may be more centralized. While increased centralization can make a single point of attack more likely, the private, permissioned nature of the blockchain, coupled with the distributed ledger aspect in which duplicate hashes of records will be stored throughout the blockchain, make hacking attempts unlikely to succeed.

Ordinarily skilled artisans will appreciate that other types of consensus mechanisms, such as proof of work (PoW), proof of stake (PoS), or proof of authority (PoA), may be used in a blockchain system. Those artisans also will appreciate that latency, computational intensity, and other potential tradeoffs may militate in favor of one consensus mechanism over another.

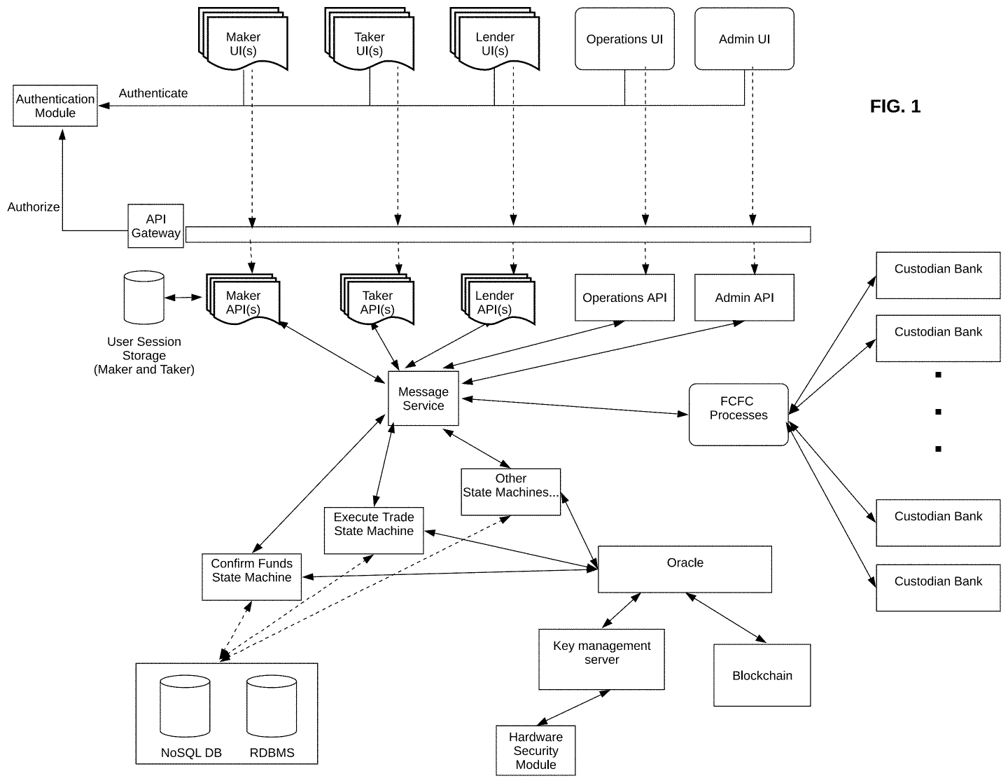

FIG. 1 shows interaction with makers, takers and lenders through a plurality of user interfaces (UIs). There also is an admin UI, for administering aspects of the system in communication with the makers, takers, and lenders. The admin UI may have one or more screens to display any or all of the information displayed in any of the UIs discussed earlier. In one aspect, the admin UI also may display management-related items, including items relating to overall financial performance, fees received, transaction history and the like. The admin UI also may access elements of one or more applications, including a master library of clients (takers, makers, lenders), potential clients, transactions, pending transactions, and other possibly relevant data for effecting transactions.

There also is an operations UI, for operation of the overall system. In this UI, in some aspects, there may be access to a manager and/or cache for current, pending, and/or recent transactions, as well as an ability to access and, where appropriate or applicable, manage and/or edit a set of rules governing behavior on the blockchain.

In one aspect, a UI for takers may show trade offers (intents to enter transactions), trade creation, trade status, and transaction history. Where applicable, the UI also may show the taker's outstanding loans and balances, and loan history, as well as providing access to loan records for the taker. A UI for makers shows potential trades, trade status, and transaction history. Where applicable, the UI also may show the maker's outstanding loans and balances, and loan history, as well as providing access to loan records for the maker. A UI with a given lender may show lender positions with borrowers (which could be takers or makers), lender terms, agreements with borrowers, outstanding loans, and loan history, as well as providing access to any loan records.

In one aspect, either separately from or as part of either the taker UI or the maker UI, there may be a UI for a borrower generally (not shown), reflecting loan offers, loan acceptances, outstanding loans, loan repayment, and loan history, among other things. Accordingly, where a lender gets involved in funding, or in bidding to fund a given transaction, depending on who the borrower is (here, either the taker or the maker), a UI with the borrower may show, for that borrower, loan offers that the borrower has received; loan acceptances that the borrower has made; outstanding loans to the borrower; loan repayments that the borrower has made; and loan history.

In one aspect, a system operator (which may be automated or human) may work with various banks, lenders, and other financial institutions via a plurality of application programming interfaces (APIs). One aspect of the present invention is that, while financial institutions such as banks, lending institutions, and other such institutions all over the world each may tend to have a unique or at least somewhat different application programming interface (API), the inventive system which facilitates the various kinds of financial transactions described here is intended to work with any and all of those APIs. In an embodiment, the inventive system will have a single API with which these various financial institutions can interface. In some aspects, the system may provide multiple APIs. From a regulatory or merely an efficiency perspective, as FX and other types of transactions involving financial instruments, securities, and the like are set up to execute on a blockchain network, it may be desirable to standardize an API for a particular type of transaction. However, in practice among financial institutions, most often all of the APIs will be different, tailored to individual institutional preferences. Accordingly, in an embodiment, a service such as Market Factory, which provides compatibility with APIs of multiple financial institutions, may be invoked. Using a service such as Market Factory can save having to come up with dozens of APIs (or more) for all of entities who may participate in transactions.

In an embodiment, there may be a database which may house a log of transactions, an orderbook listing orders for transactions, a log of loans which have been made, pending lending transactions, user profiles, and auditing and logging rules and practices. The above-referenced master library may be housed in such a database. Contents of the above-referenced cache also may reside in the database, or may be transferred automatically to the database after a period of time, depending on the rules for the cache and the size of the cache, among other things. Ordinarily skilled artisans will understand well how to relate the cache to the database to effect appropriate operation within the overall system.

In one aspect, each of the taker, the maker, and the lender will have recourse to a system regulating access to funds. For consistency of description, in FIG. 1 these systems are referred to as banking systems, but it should be understood that “banking” here is intended to refer merely to a source of funds, and not to a banking institution in the strictest sense.

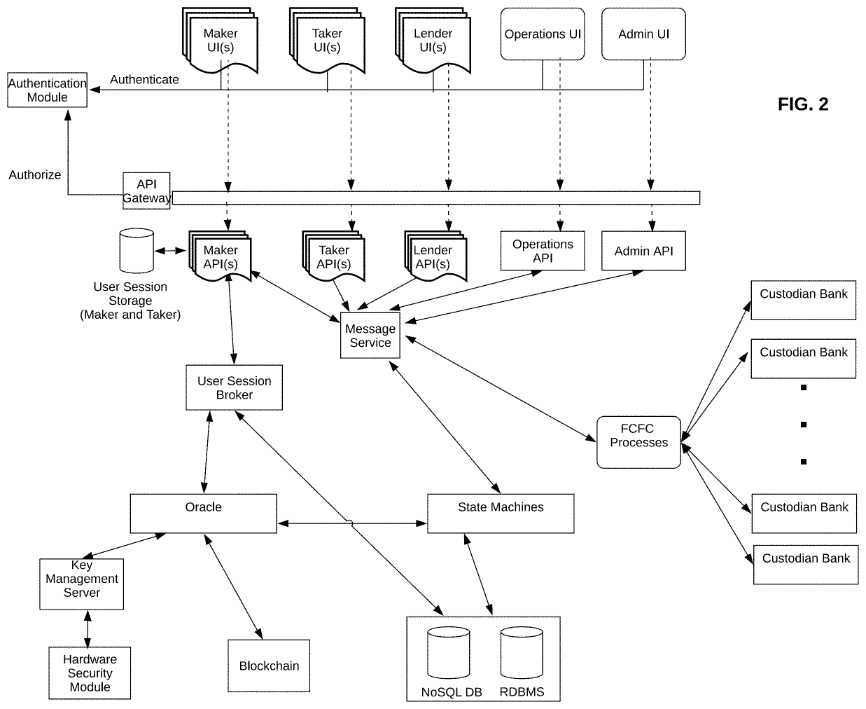

Looking further at FIG. 1, the UIs and APIs connect through an API gateway. In an embodiment, that gateway may be implemented using Amazon API gateway. An authentication module enables users accessing the system through one of the UI to be authenticated. In an embodiment, the authentication module may be implemented using Amazon Cognito. Once a user is authenticated, authorization may be provided through the API gateway. In an embodiment, the authentication module needs to link with an actual user. As shown in FIG. 2, that linking may be effected by a user session broker.

According to embodiments, one or more custodian banks provide funds, in different currencies, to effect FX transactions. Depending on the situation, a single custodian bank may provide funds in more than one currency; multiple custodian banks may provide funds in the same currency; or each custodian bank may provide funds in a single currency. The availability of funds for FX transactions will be part of the input for FCFC processes, which will be discussed in more detail herein, but which are shown as a block in FIG. 1. It should be noted that the FCFC processes block appears outside of the blockchain in FIG. 1. However, certain aspects of those processes, for example, the FCFC themselves, will reside on the blockchain. Records of deposits and withdrawals, involving exchange of FCFC between takers and makers, will be recorded on the blockchain according to one aspect. Additionally, in one aspect initiation and execution of trades also will be recorded on the blockchain. Verification of balances also may be effected by accessing records on the blockchain. Finally, a loan contract between a lender and a borrower (taker or maker) may be preserved on the blockchain.

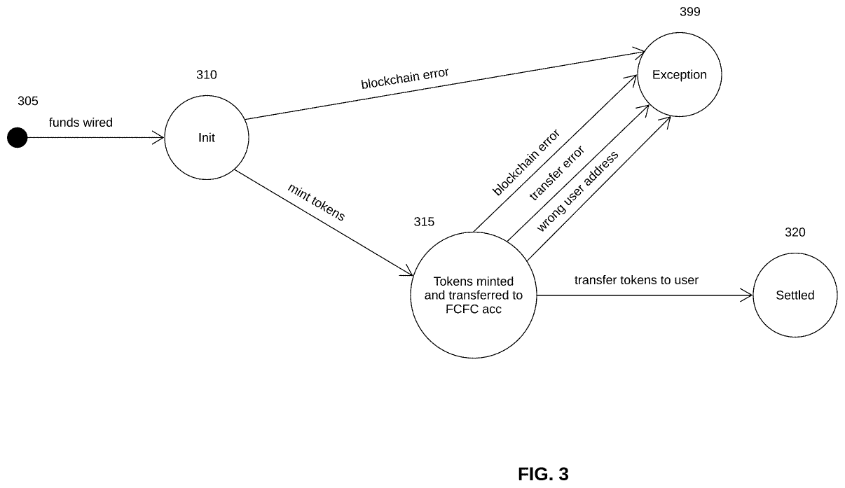

As noted earlier, the blockchain receives data from a trusted source, called an oracle. As FIG. 1 shows, the oracle communicates with the various state machines, shown separately in FIG. 1, but as a single entity in FIG. 2, which shows an alternative embodiment of the system in accordance with aspects of the invention. FIGS. 3-5 show the state machines, which will be discussed in more detail below. The state machines also communicate with central storage in the system. This is separate storage from the blockchain, and may contain not only records that are stored on the blockchain, but also additional records of various types as discussed herein.

Based on one or both of the UIs and smart contracts, the oracle pieces together details of a particular transaction, including identities (addresses) of a taker and a maker, currencies involved, and the amounts involved. The oracle sends the raw transaction to a key management server, which generates keys, signs raw data, and returns signed data. In the embodiments of FIGS. 1 and 2, key management is centralized. In other embodiments, each individual institution may manage its own key.

In the embodiments of FIGS. 1 and 2, as part of centralized key management, a hardware security module (HSM) is a physically separate device that generates private keys for encrypted transactions in accordance with an embodiment. System users (makers, takers, and lenders) use these private keys in this embodiment, instead of generating their own private keys. The HSM not only generates the private keys, but also retains them, hindering replication and/or hacking.

In order to be able to generate a key, a token first must be initialized. The oracle issues a request to the HSM, via the key management server to do the initialization. Because the oracle is a trusted source, the HSM will perform the initialization. Next, a user PIN must be set. This request also comes to the HSM from the oracle via the key management server. Responsive to the request, the HSM will set the user PIN.

Next, the oracle will request the generation of a key. The HSM receives this request via the key management server, and generates the key. Finally, the oracle will request the HSM to sign the transaction. Once again, the request goes from the oracle to the HSM via the key management server. Responsive to raw transaction data from the oracle, the HSM hashes that data, signs the hash, and returns the signed hash.

One or more message services facilitates messaging communication between the various APIs, which as noted earlier play a role in authentication, with other parts of the system. In various embodiments, Amazon's Simple Notification Service (SNS) or Simple Queue Service (SQS) may provide the indicated messaging services. SNS pushes messages, while SQS queues them.

In an embodiment, takers will connect directly to a UI in the system and execute trades through that UI.

In an embodiment, a maker could be a person confirming a trade with a taker. Alternatively, a maker could employ an algorithm. Makers access the system to make trades available (i.e. to indicate interest in trades). In an embodiment, makers have their own UIs. In such a circumstance, use of a facility such as Market Factory can facilitate connecting more makers to the system.

In one aspect, ordinarily skilled artisans will appreciate that takers just want to look to see if there are trades they want to accept, so they may not/do not need or care about their own UI.

FIG. 3 shows a diagram of a state machine for a deposit transaction, in which funds are entered into the system, and fully collateralized fiat coins (FCFC) are transferred to the user entering the funds. In blockchain parlance, the term “tokens” is used conventionally. Tokens are minted and often are burned after usage. In one aspect of the invention, as will be discussed, tokens need not be burned after usage. Instead, they can be retained in the system and used for further transactions. FCFC are the currency representation of the tokens. FCFC differs from tokens in the cryptocurrency world in that FCFC are tied to fiat currency of countries—for example, US dollars (USD); Australian dollars (AUD); euros (EUR); British pound sterling (GBP); Canadian dollars (CAD); and Japanese yen JPY).

Looking at FIG. 3, at 305 funds are wired in, and at 310 the deposit is initiated. Aspects of the system account for various kinds of errors, leading to an exception state at 399. For example, at funds intake a blockchain error, such as an attempt to wire funds to an account that the blockchain does not recognize, could lead to an exception.

Assuming there is no problem with the intake of funds, at 315 tokens are minted and are transferred to an FCFC account. Again, there could be a blockchain error, such as an unrecognized account; a transfer error (for example, a system glitch leading to an inability to complete the transfer); or an incorrect user address, all leading to an exception condition 399. Assuming no problem with the minting and transfer, then at 320 the deposit is settled.

Looking a little more closely at the deposit process, when funds are wired in to a bank, the bank will instruct that tokens be minted. The tokens will reside on the blockchain.

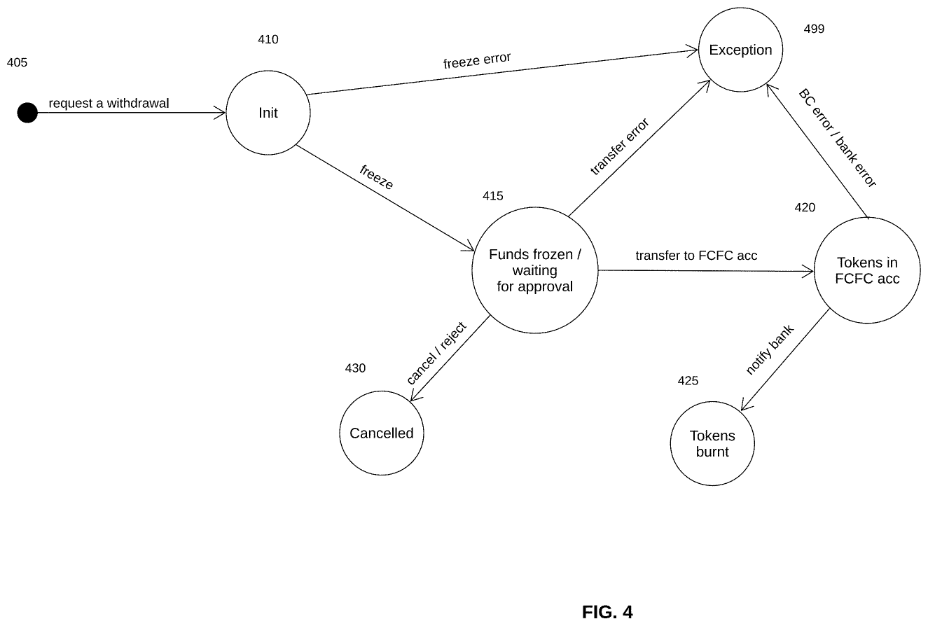

FIG. 4 shows a diagram of a state machine for a withdrawal transaction. In a withdrawal situation, funds are returned to a user, and the underlying tokens (FCFC) are burned so as to avoid a double-spending situation. Looking at FIG. 4, at 405 a trader (maker/taker) may request a withdrawal. At 410 the withdrawal request is processed and initiated. The first thing that needs to happen is that the funds to be withdrawn need to be frozen, to avoid double spending. Accordingly, at 415 a freeze is initiated. In some circumstances, there may be an error in getting that freeze instruction either sent out or implemented properly. An exception, at 499, would be the result.

Also at 415, approval may be pending for the freeze instruction. The user may decide to cancel the withdrawal, or the system may determine that the funds cannot be frozen (for example, because the size of the withdrawal exceeds the amount of funds available for withdrawal). In either of those circumstances, at 430 the request for withdrawal may be cancelled or refused.

Once the funds are frozen, there may be an error in transferring the funds (for example, there may be incorrect account information for the funds transfer). In this event, the state would return an exception at 499. Otherwise, the withdrawal request would invoke a transfer to an FCFC account at 420. At 425, a number of FCFC corresponding to the amount of the funds to be withdrawn would be burned. If there is some kind of blockchain error or bank error, an exception condition would be returned (499).

In one aspect, a lender who has had FCFC sitting in the system, available for funding of trades, also may request withdrawal. The state machine would proceed through similar steps to the ones just described in order to effect that withdrawal.

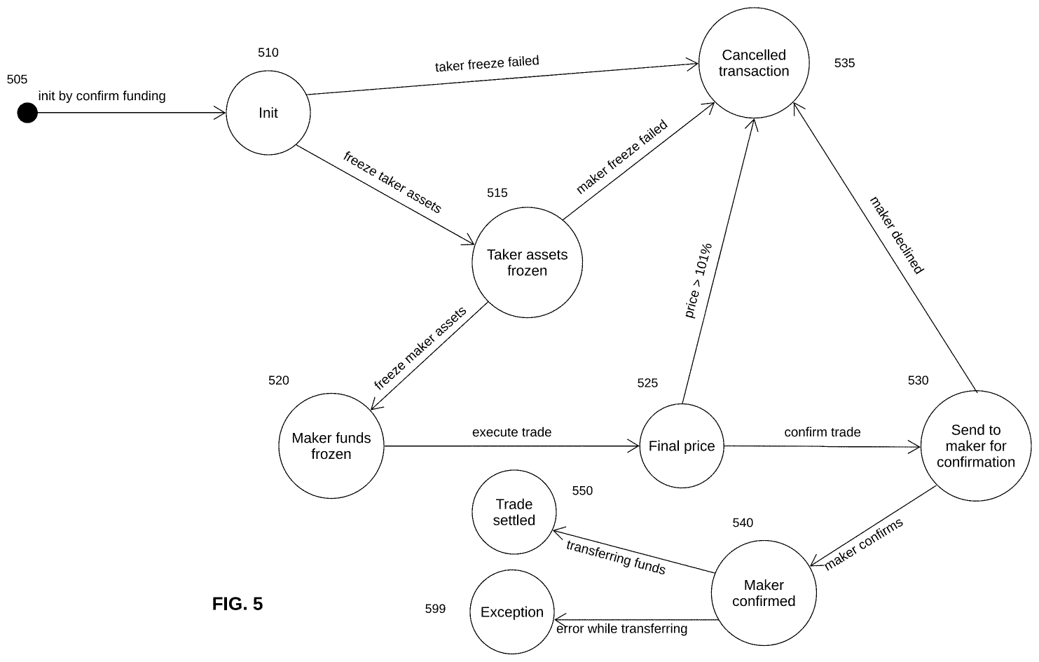

FIG. 5 shows a diagram of a state machine for a trade transaction. After initialization at 505, at 510, the trade state initializes by confirming that both the taker and the maker are funded. At 515, the taker's funds are frozen, and at 520, the maker's funds are frozen. In one aspect, this sequence occurs because the taker is the one initiating the trade, and so the taker's funds would be reviewed first. In another embodiment, the maker's funds may be frozen first. At 535, if freezing of either the taker's funds or the maker's funds fails for some reason, the transaction would be cancelled.

At 525, after both the taker and the maker funds are frozen, a trade may be executed, and a final price may be set. In an embodiment, when funds are frozen, the amount frozen exceeds the agreed price—merely by way of example, 101% of the agreed price for both the taker funds and the maker funds. The freeze amount is higher than the agreed price to account for possible fluctuations in values between the maker's first indication of interest in trading and the agreement between taker and maker on price. Setting the amount a little higher can prevent having a transaction voided because of insufficient funds. Ordinarily skilled artisans will appreciate that when the price goes down rather than up, there will be sufficient funds frozen, so that the transaction can go forward. Since transactions according to aspects of the invention occur in a very short period of time, the 101% figure is intended to encompass all but unusual currency fluctuations. If for some reason the figure is insufficient, the transaction will be cancelled.

Once a final price is set, at 530 the trade is sent to the maker for confirmation. If the maker confirms, then that state is set at 540. Funds will be transferred, and at 550 the trade will be settled. If the maker decides to decline the trade, then at 535 the transaction will be cancelled. At 599, an exception condition is set to account for an error while transferring funds.

According to an embodiment, for example in FIG. 1, each described state machine may constitute separate services. In another embodiment, for example in FIG. 2, two or more of the described state machines may be combined into a single service.

This discussion of FIGS. 3-5, presents some aspects that are worthy of discussion. First, in general, because aspects of the present invention enable financial transactions, such as foreign currency exchange transactions, to be funded before they go through, in some cases before the taker and maker even agree on terms, closing of the transactions happens much faster than before, because there is no need for the parties to check on each other to see whether each is able to engage in the transaction. Second, in the foregoing discussion of FIGS. 3-5, there was no mention of whether a borrower of funds (the taker and/or the maker) would repay the loan immediately, or within a predetermined period of time, or over a longer period of time. For example, there may be a series of currency exchanges which the taker would like to make, in fairly short order (for example, within the current day). On one hand, frequent credit extension and frequent loan payments can be cumbersome. On the other hand, the lender may wish to get the funds back sooner rather than later, so as to have them available to lend again, possibly to someone other than the taker. Relatedly, the manager of the overall system may be compensated on a per-loan basis, or a per-transaction basis. Consequently, depending on the management of the system, there may be financial incentives to the manager, as well as to the lender, to have the loan amounts repaid after each transaction, rather than “letting them ride”.

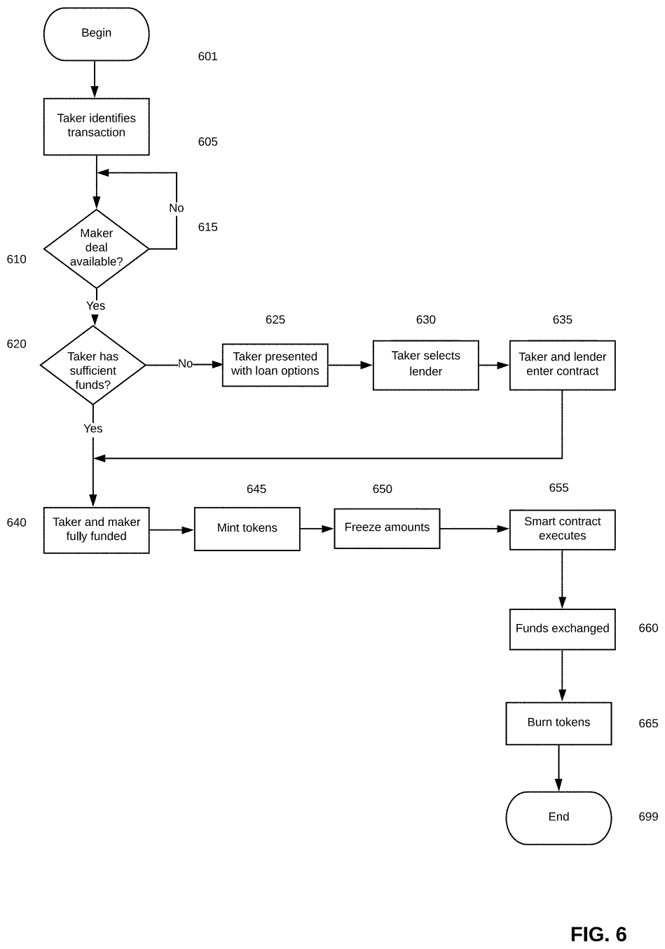

FIG. 6 is a flowchart depicting the flow of a taker's side of a foreign exchange transaction in accordance with aspects of the invention. At 605, a taker identifies a transaction to be initiated, and disseminates that information on the blockchain. At 610, the taker awaits availability or presentation of an offer from a maker. In one aspect, the taker receives the best available option. In another aspect, the taker may receive a response from one or more makers who may be willing to enter into the transaction. The flow loops through that waiting until there is a maker deal available. At 620, if there is a maker deal available, there is a determination of whether the taker has sufficient funds to complete the transaction. Here, it should be noted that the sequence of finding a maker, and determining sufficiency of funds need not be in the order presented in FIG. 6. Since one aspect of the present invention is the pre-funding of transactions, the taker may wish to know, before even identifying the transaction, that there are sufficient funds available in the currency to be traded, either in the taker's account or available from a lender, for the taker to engage in the transaction. The timing need not be essential to the overall speed of the transaction because, in one aspect, a taker may be prequalified for credit from one or more lenders, so that the taker knows that there is ready access to sufficient funds.

At 620, if the taker has sufficient funds, then at 640, assuming that the taker and maker have agreed to do the exchange, both the taker and the maker will be fully funded. If the taker does not have sufficient funds, then at 625 the taker is presented with loan options from one or more lenders, to provide sufficient funds for the transaction. In one aspect, the taker simply may be presented with the best of the available loan options. At 630, the taker identifies or selects the lender, and 635, the taker and the lender enter into a contract, normally off the blockchain, to provide funds for the taker to engage in the transaction. Flow then would proceed to 640.

In one aspect, consistent with the description in FIG. 3, in response to wiring in of funds, FCFC tokens are represented as balances in an FCFC account. Alternatively, in FIG. 6, at 645, tokens are minted for both the taker (in the currency the taker is using to make the currency purchase) and the maker (in the currency the taker is looking to buy, and the maker is willing to sell). These tokens stay within the blockchain. In an embodiment, as described with respect to FIG. 3, freezing of amounts sufficient to complete the transaction occurs based on the FCFC account balances. Alternatively, in FIG. 6, at 650, respective requests go out from the taker oracle and the maker oracle (or from a single oracle, depending on the embodiment) to the taker banking system and the maker banking system to freeze amounts in the taker and maker accounts, sufficient to complete the transaction. Once the taker and maker banking systems provide confirmation of the freezing of the amounts, at 655 the smart contract for this transaction executes, because the smart contract has information confirming that the trade is fully funded. At 660, funds get exchanged between the taker and maker banking systems. In one embodiment, this step is done outside the blockchain. As described in FIG. 3, the minted FCFC tokens may be retained for future transactions, as they can be moved to different blockchain accounts as credits and debits. The minted tokens need only be burned when there is a withdrawal of funds. Alternatively, as shown in FIG. 6, after the funds are exchanged, at 665 the tokens that were minted to carry out the foreign exchange transaction are disposed of, or “burned,” so that they cannot be used again, for example, by a cryptocurrency miner or other entity, thus avoiding double spending of the tokens.

Similarly to the discussion of FIG. 3, this discussion of FIG. 6 presents some other aspects that are worthy of discussion. First, in general, because the present invention enables financial transactions, such as foreign currency exchange transactions, to be funded before the trades go through, in some cases before the taker and maker even agree on terms, closing of the transactions happens much faster than before, because there is no need for the parties to check on each other to see whether each is able to engage in the transaction. Second, in the foregoing discussion of FIG. 6, there was no mention of whether the borrower (in this case, the taker) would repay the loan immediately, or within a predetermined period of time or over a longer period of time. For example, there may be a series of currency exchanges which the taker would like to make, in fairly short order (for example, within the current day). On one hand, frequent credit extension and frequent loan payments can be cumbersome. On the other hand, the lender may wish to get the funds back sooner rather than later, so as to have them available to lend again, possibly to someone other than the taker. Relatedly, the manager of the overall system may be compensated on a per-loan basis, or a per-transaction basis. Consequently, depending on the management of the system, there may be financial incentives to the manager, as well as to the lender, to have the loan amounts repaid after each transaction, rather than “letting them ride”.

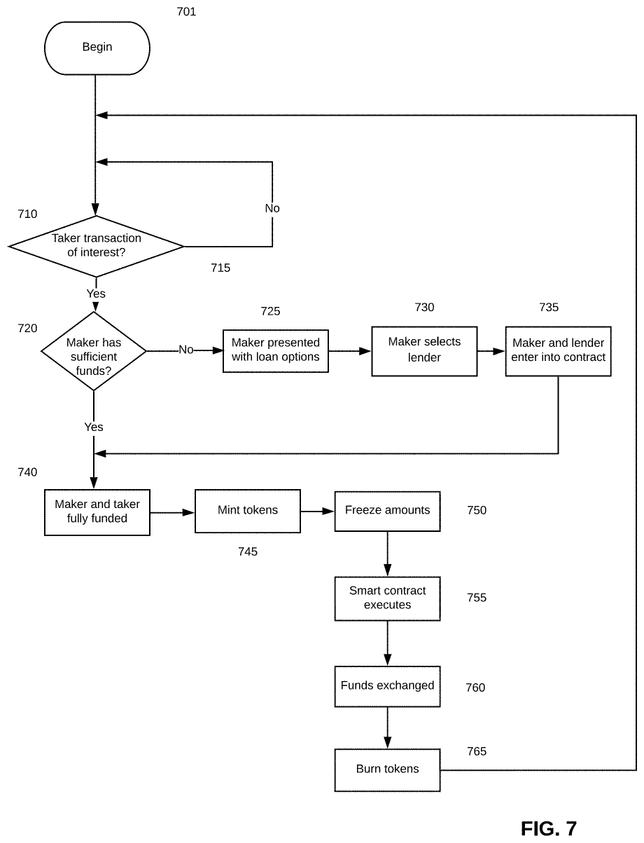

FIG. 7 is a flowchart depicting the flow of a maker's side of a foreign exchange transaction in accordance with aspects of the invention. At 710, the maker waits for a potential transaction with a taker, and evaluates it to see if it is of interest (e.g. worth bidding on). If not, at 715 the maker disregards that taker transaction, and goes on waiting. If the transaction is of interest, at 720 there is a determination of whether the maker has sufficient funds to complete the transaction. Here, similarly to the case with FIG. 6, it should be noted that the sequence of finding a maker, and determining sufficiency of funds need not be in the order presented in FIG. 7. Since one aspect of the present invention is the pre-funding of transactions, the maker may wish to know, before even responding to a particular transaction opportunity with a taker, that there are sufficient funds available in the currency to be traded, either in the maker's account or available from a lender, for the maker to engage in the transaction. The timing need not be essential to the overall speed of the transaction because, in one aspect, a maker may be prequalified for credit from one or more lenders, so that the maker knows that there is ready access to sufficient funds.

If the taker has sufficient funds, then at 740, assuming that the taker and maker have agreed to do the exchange, both the taker and the maker will be fully funded. If the maker does not have sufficient funds, then at 725 the maker is presented with loan options from one or more lenders, to provide sufficient funds for the transaction. At 730, the maker selects the lender, and 735, the maker and the lender enter into a contract, normally off the blockchain, to provide funds for the maker to engage in the transaction. Flow then would proceed to 740.

As noted earlier with respect to FIG. 6, in one aspect, consistent with the description in FIG. 3, in response to wiring in of funds, FCFC tokens are represented as balances in an FCFC account. Alternatively, in FIG. 7, at 745, tokens are minted for both the taker (in the currency the taker is using to make the currency purchase) and the maker (in the currency the taker is looking to buy, and the maker is willing to sell). These tokens stay within the blockchain. In an embodiment, as described with respect to FIG. 3, freezing of amounts sufficient to complete the transaction occurs based on the FCFC account balances. Alternatively, in FIG. 7, at 750, respective requests go out from the taker oracle and the maker oracle (or from a single oracle, depending on the embodiment) to the taker banking system and the maker banking system to freeze amounts in the taker and maker accounts, sufficient to complete the transaction. Once the taker and maker banking systems provide confirmation of the freezing of the amounts, at 755 the smart contract for this transaction executes, because the smart contract has information confirming that the trade is fully funded. At 760, funds get exchanged between the taker and maker banking systems. In one embodiment, this step is done outside the blockchain. As described in FIG. 3, the minted FCFC tokens may be retained for future transactions, as they can be moved to different blockchain accounts as credits and debits. The minted tokens need only be burned when there is a withdrawal of funds. Alternatively, as shown in FIG. 6, after the funds are exchanged, at 765 the tokens that were minted to carry out the foreign exchange transaction are disposed of, or “burned,” so that they cannot be used again, for example, by a cryptocurrency miner or other entity, thus avoiding double spending of the tokens. After this, the maker may go back to listening for further transactions of interest from takers.

It should be noted that, as discussed elsewhere herein, an entity may wish to be a taker in one transaction, and a maker in another. Consequently, a given entity need not be limited to a particular role. Lenders also may wish to be takers or makers, depending on the transactions at hand.

Ordinarily skilled artisans will appreciate that there may be a considerable amount of parallelism between the flows of FIGS. 6 and 7, as the parties to the transaction, the taker and the maker, may engage in similar steps to ensure that their transactions are funded before entering into a trade. The other aspects discussed above relative to FIG. 6 with respect to the taker apply to the maker as well, including transaction speed and loan repayment.

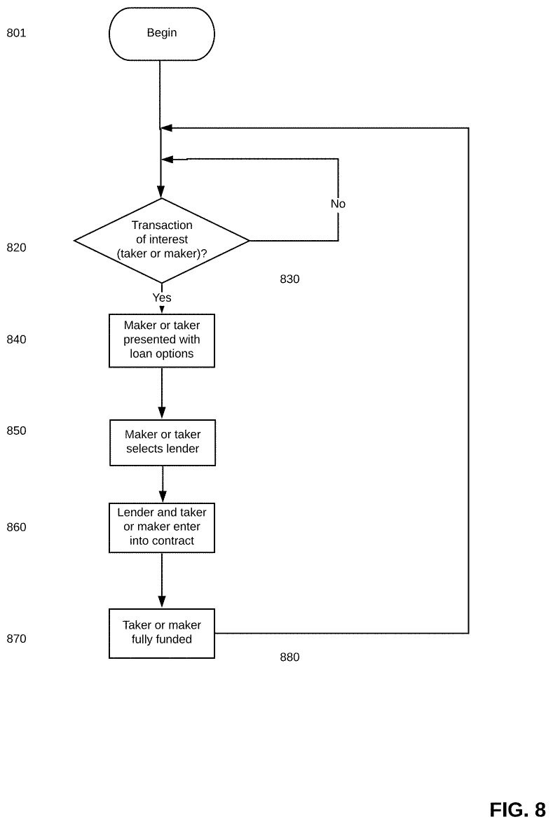

FIG. 8 is a flowchart depicting the flow of a lender's potential participation in a foreign exchange transaction in accordance with aspects of the invention. At 820, a lender waits for a transaction, which may be presented to the lender in any of several different ways. Without limiting how this might happen, for example, a taker or a maker may identify a transaction that potential lenders can see. Either the transaction may be posted generally for lenders to look at as a potential loan, or a taker or maker may reach out to a lender directly to inquire about the possibility of a loan. In one aspect, a taker or a maker wanting or needing a loan may be presented with a best option from a list of lenders. Lenders can make their terms available beforehand.

If the identified or presented transaction is of interest, then at 840 the taker or maker may receive loan options, either on a competitive basis from multiple lenders, or on a sole source basis with an individual lender. In one aspect, the taker or maker simply is presented with the best option from those available. In one aspect, the lender may present the loan inquirer (taker or maker) with loan options, including term, interest rate, etc. Depending on how the transaction comes to the lender, the lender may be putting out a competing bid with other lenders, or may be dealing directly with the taker or maker on a one-on-one basis.

At 850, from the various loan and lender options that the taker or maker may receive, the taker or maker may select a lender. Terms may be discussed off the blockchain. If the parties agree on loan terms, at 860 the lender will enter into a contract or loan agreement with the taker or maker. At 870, once the contract is done, the taker or maker that is the other party to the contract will be fully funded. At 880, the lender then can go back to 820 to wait for more potential transactions.

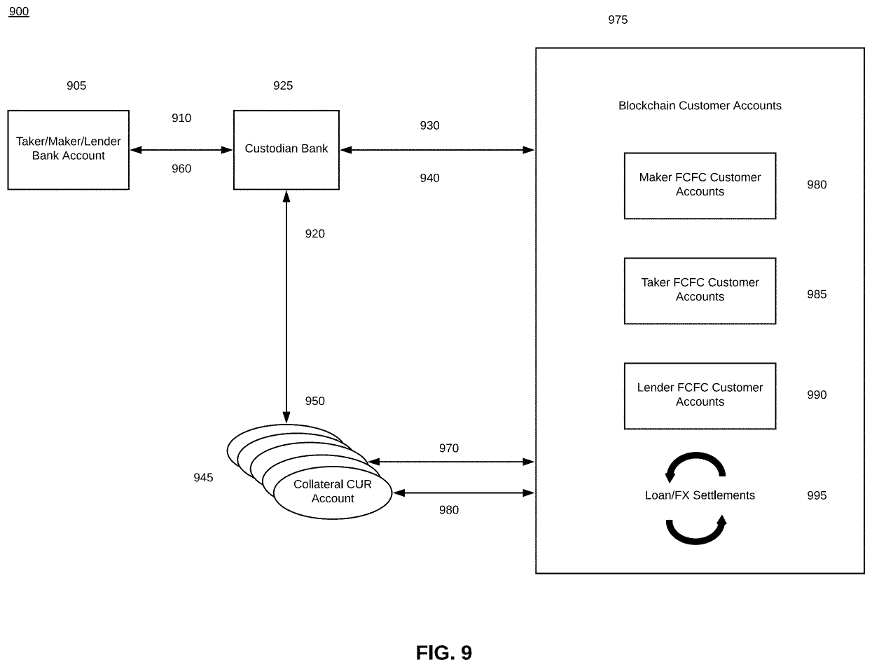

FIG. 9 depicts an overall sequence of operation 900 for an FX transaction according to embodiments. The depicted exemplary FX transaction involves a taker/maker/lender bank account 905, a custodian bank 925, a collateral currency account 945, and admin/master 975, including maker FCFC accounts 980, taker FCFC customer accounts 985, lender FCFC accounts 990, and loan/FX settlements 995.

At 910, a taker/maker/lender wires funds from its account 905 to a custodian bank 925. The wire could be accomplished in any number of ways, including but not limited to a Federal wire, SWIFT, or a custodian bank demand deposit account (DDA). At 920, the custodian bank 935 receives the wire message, and credits an FCFC collateral CUR account 945 for the taker/maker using known money transfer processes.

At 930, custodian bank 925 communicates details (including but not limited to, for example, FCFC account number, reference number, currency, and amount) to admin/master 975. Admin/master 975 issues the FCFC and deposits the FCFC into the appropriate account. At 940, a maker/taker/lender may request withdrawal from its FCFC account via the admin/master 975. In an embodiment, there is an approver to authorize the withdrawal. Admin/master 975 communicates details of the withdrawal (including but not limited to, for example, FCFC account number, reference number, currency, and amount) to custodian bank 925.

At 950, custodian bank 925 receives the communication from admin/master 975 via appropriate UIs and APIs, and debits the collateral CUR account 945 using conventional money transfer processes. At 960, similarly to the process described above at 910, custodian bank 925 wires funds to the taker/maker/lender bank account 905.

At 970, daily account reconciliation occurs. In this process, custodian bank 925 may provide a daily account statement to admin/master 975. The format of this statement may take various forms. One example would be the SWIFT 950 format. Other existing formats may be used. Admin/master 975 may import balances and transaction details, as well as relevant FCFC account detail, and may perform the reconciliation.

FIG. 9 is intended as an overview of the process. As a practical matter, there will be multiple bank accounts 905, multiple custodian banks 925, multiple collateral CUR accounts 945 (shown in FIG. 9), and multiple accounts 980, 985, and 990 which the admin/master 975 will handle.

As an alternative to the just-described process, there may be a DDA at 980 admin/master 975 may have a DDA interface to the collateral CUR accounts, for performing the reconciliation.

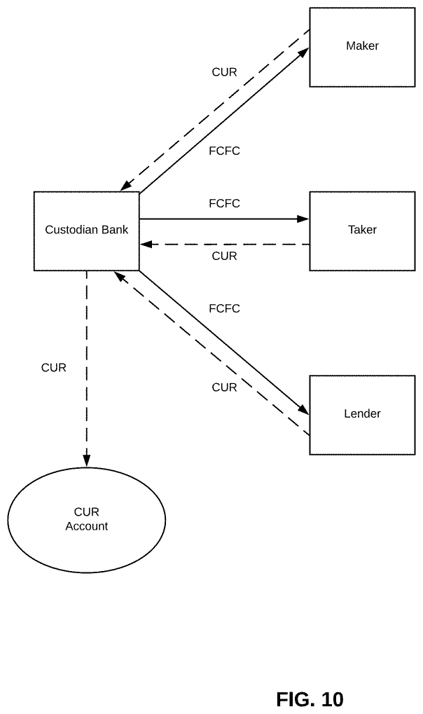

FIG. 10 depicts creation of FCFC according to an embodiment. Each FCFC in a given currency is backed by a unit of the same, fiat currency. For example, a one dollar FCFC coin is backed by a dollar in fiat currency. As a result, that one dollar FCFC coin will retain its value as one dollar in fiat currency. The value of the dollar varies with respect to other fiat currencies (e.g. GBP, EUR, JPY, and the like), meaning that the one dollar FCFC coin that a participant in an FX transaction holds will “behave” just as one dollar in US fiat currency will behave, and so always will be worth one dollar.

In order to obtain FCFC, a market participant, be it a market maker, a price taker, or a lender, places fiat currency with a custodian bank in return for a number of FCFC coins in that currency. FIG. 10 shows each type of market participant engaging in this kind of transaction with a custodian bank. Different custodian banks will deal in different currencies. A given market participant also may deal in different currencies. As noted earlier, there are multiple fiat currencies which market participants may use to purchase FCFC. Different fiat currencies mean different FCFC coins in those currencies.

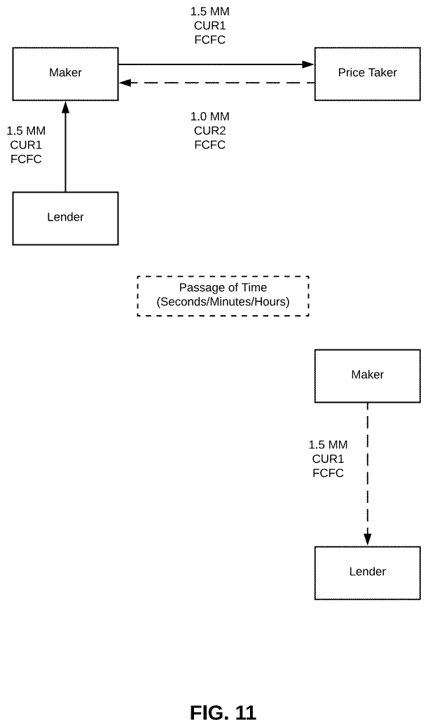

FIG. 11 shows an example of a simple FX transaction employing FCFC. In this depiction, FCFC backed by one fiat currency can be traded for FCFC backed by a different fiat currency at a market exchange rate. In accordance with aspects of the invention, each party to the transaction is required to hold the necessary FCFC to execute the trade, before the trade is executed. This requirement is part of the “fund then trade” aspect of the invention.

In order to fund its end of the transaction, a maker or taker can buy FCFC using fiat currency, or can borrow FCFC from a lender. In the case of borrowing, FCFC typically will be paid back later in the day, either during or at the end of the trading day. However, as will be discussed below, loans can be of varying durations, depending on the needs and desires of the borrower.

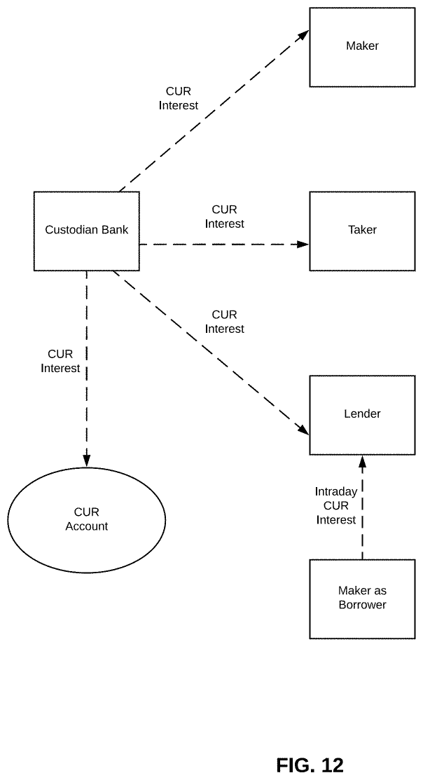

FIG. 12 depicts one implementation of payment and receipt of interest at the end of a month. In an embodiment, interest is paid in fiat currency. In one aspect, the custodian bank will pay interest to the entity that owns the FCFC, just as if that entity held fiat currency on deposit in that same amount. The entity could be a taker, a maker, or a lender.

FCFC borrowers will pay interest to FCFC lenders based on a previously determined rate for the length of time (in some cases, number of minutes) that the loan was outstanding

In connection with FIG. 12, it should be noted that the Figure depicts lenders earning interest in three ways. First, as noted, lenders earn interest from a custodian bank on a daily basis, corresponding to the amount of FCFC that the lender holds with that custodian bank. In an embodiment, the custodian bank pays the interest monthly, as also noted earlier. Second, lenders can earn interest from borrowers (in FIG. 12, for example, this party would be a maker) who wait beyond the trading day to repay their FCFC to the lender. Third, a lender who keeps its FCFC with a custodian bank past the trading day may earn interest from that custodian bank.

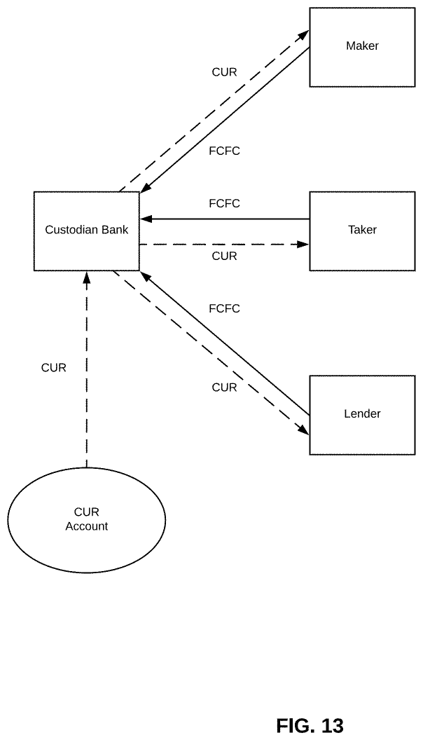

FIG. 13 depicts one example of market participants redeeming FCFC. In one aspect, as noted, market participants can hold FCFC overnight/indefinitely and earn daily interest in fiat currency. In some implementations, this option will be attractive for lenders. Keeping funds in FCFC can provide lenders a source of income, in the form of overnight fiat interest, at terms that may be more attractive than otherwise would be available if the lender were to move funds in and out of the system.

In one implementation, market makers and price takers can “sell/burn” FCFC in their accounts, and can instruct the custodian bank or other financial institution to wire funds back to their traditional fiat currency accounts. In some aspects, it will be possible that market makers and/or price takers who “burn” FCFC in one currency, obtain the FCFC in another currency.

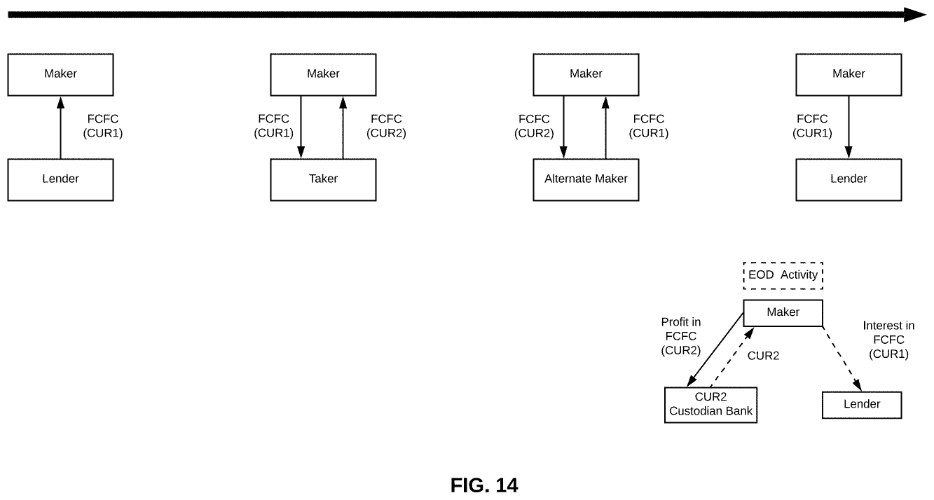

In FIG. 14, first the maker borrows FCFC in the first fiat currency (CUR1) from a lender. The maker then converts the CUR1 FCFC to CUR2 FCFC through a transaction with a taker. After this step, the maker converts the CUR2 FCFC back to CUR1 FCFC through a trade with another maker (denoted an alternate maker in FIG. 13). Next, the first maker repays its loan to the lender. Finally, the profit that the first maker made on the two transactions goes to a custodian bank as CUR2 FCFC, and the custodian bank pays CUR2 as fiat currency to the first maker. That first maker then pays interest to the lender as CUR1 FCFC. In such a transaction, the first maker is betting that the profit to be made from the currency arbitrage exceeds the amount of interest to be paid to the lender for lending the funds to enable the first maker to engage in the overall transaction.

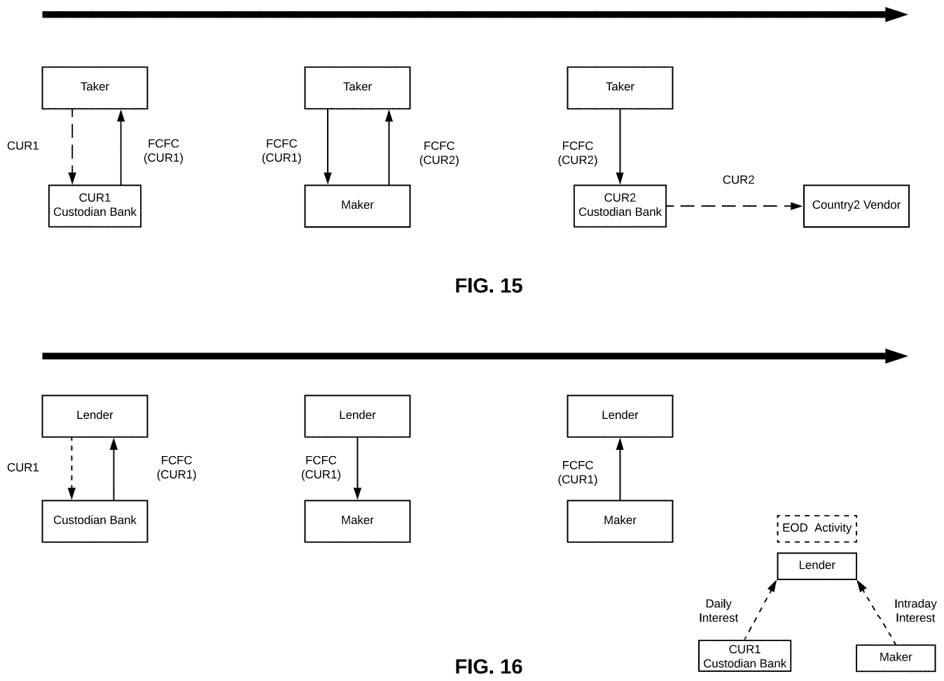

FIG. 15 depicts a transaction in which a corporation, resident in a jurisdiction with a first fiat currency, wishes to repay a vendor in another jurisdiction with a second fiat currency. This repayment will involve a transaction in which the corporation (in this example, a price taker) purchases FCFC in a first fiat currency from a first custodian bank. The corporation then enters into a transaction to exchange the FCFC in the first fiat currency for FCFC in the second fiat currency, which is the fiat currency of the vendor. The corporation then can transmit the FCFC in the second fiat currency to a further custodian bank, which then can pay the vendor in the fiat currency. In general, the custodian bank may handle either the sale of FCFC in the first fiat currency, or the receipt of FCFC in the second fiat currency for transmission to the vendor. Presently, it is possible, though unlikely that the custodian bank would handle both. Effectively, the custodian bank would be on both sides of the transaction.

FIG. 16 depicts a loan transaction. In this transaction, a lender deposits CUR1 with a custodian (for example, a bank) in exchange for CUR1 FCFC. The lender then lends the CUR1 FCFC to a market maker over a blockchain-based system in accordance with aspects of the invention. Later in the day, the maker repays the loan to the lender. At the end of the day, the lender earns interest from two sources: the maker, who pays interest on the loan; and the custodian bank, who pays interest on the fiat currency on deposit.

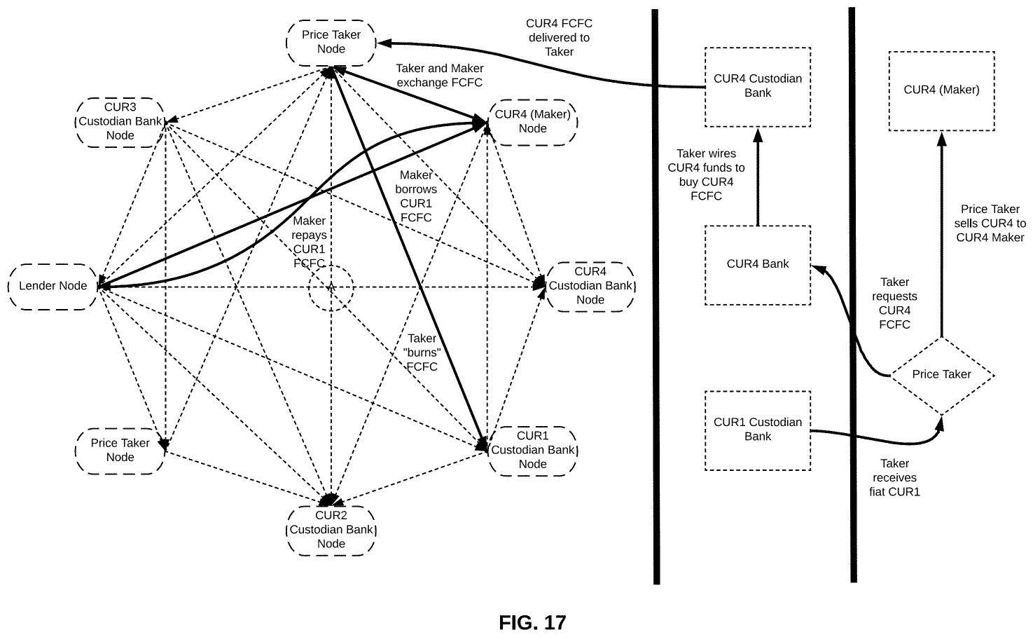

FIG. 17 is a diagram that describes an FX trade, demonstrating the ability to speed the process significantly. In FIG. 17, CUR1 to CUR4 denote different fiat currencies. In an example, CUR1 could be USD; CUR2 could be EUR; CUR3 could be GBP; and CUR4 could be CAD.

FIG. 17 happens to show a number of blockchain members, including CUR1 to CUR3 custodian nodes; a CUR4 bank node; a lender node; two price taker nodes; and a market maker node (associated specifically with CUR4). However, as discussed earlier, according to an embodiment, these market participants would not have nodes on the blockchain. All of these participants would go through the admin or master. Accordingly, the depiction in FIG. 17 may be understood to represent a range of embodiments, from nodes on the blockchain for all of the participants, to no nodes on the blockchain for any of the participants, to anything in between.

In FIG. 17, the following steps constitute a transaction among a price taker, seeking to convert CUR4 to CUR1; a market maker, who wishes to offer a price to provide CUR1 in exchange for the price taker's CUR4; and a lender who lends CUR1 to the market maker to enable the market maker to engage in the transaction:

A price taker with CUR4 funds available in its nostro (a foreign currency account held by one bank for another in a different country) seeks to convert those funds to CUR1.

The price taker requests the nostro bank to wire funds to the custodian bank for the issuance of CUR4 FCFC.

A market maker, with no available funding, seeks to make a price to execute an FX trade with the price taker.

The market maker borrows funds for payment in CUR1 FCFC. In an embodiment, the lender is pre-selected for the market maker, having the most favorable terms based on the market maker's prior indication of credit-worthiness, various aspects of the prospective loan agreement including loan period and interest rate, and the like. In other embodiments, the market maker is able to select the lender, using the market maker's own criteria.

The market maker displays its FX quote.

The price taker decides to accept the quote, and to enter into a transaction with the market maker to exchange CUR4 for CUR1.

The market maker and the price taker exchange FCFC.

The funds are exchanged between accounts.

The market maker closes its CUR4 position, selling the CUR4 FCFC and receiving CUR1 FCFC.

The market maker repays the CUR1 loan received by returning CUR1 FCFC.

In the just-described transaction, the price taker was already fully funded, while the market maker had to go out and get funding. Ordinarily skilled artisans will appreciate that in other kinds of transactions, it is possible that both parties are already fully funded, with no need to seek a lender. Alternatively, it could be the taker who needs funding, while the maker is fully funded. As a yet further alternative, both the taker and the maker may need funding.

When the lender enters into a loan agreement with a borrower (taker or maker), one of the terms to be negotiated is the time of repayment. In an embodiment, the duration of the loan may be quite short—as long as it takes for the maker and the taker to complete their transaction, after which the borrower will have the funds with which to repay the lender. Short term loans with prompt repayment enable a lender to make multiple loans in a day, at different terms, some of which may be more favorable for the lender with respect to some borrowers than with respect to others. If the lender receives prompt repayment, the lender has the option to try to lend to the same borrower or same class or category of borrowers. Alternatively, the lender can decide to try to lend to a different borrower or a different class or category of borrowers.

In one aspect, the lender may provide a longer repayment term, for a borrower from whom the lender is able to extract favorable terms, particularly where that borrower routinely engages in multiple transactions per day. In that circumstance, reduced overhead through reduction in the number of loan transactions and repayments may be attractive to the borrower. For similar reasons, that reduced overhead scenario may be more attractive to the lender as well. Alternatively, the lender may wish to lend funds over and over again, particular where the lender is able to charge a fee as well as receive interest. Such re-loaning of funds also may be attractive to the manager of the overall system, because the manager may be able to charge a per-transaction fee on the loans as well as on the trades themselves.

As also discussed, a lender may leave FCFC in the system, with a custodian bank, rather than take it out, because the FCFC can earn overnight interest, providing a short-term return. If the lender is going to participate in lending on a concerted basis, then having FCFC readily available in the system, in one or more currencies, could be a source of additional revenue for the lender.

In view of the foregoing, ordinarily skilled artisans will appreciate that a system according to aspects of the present invention brings together parties interested in transactions such as FX, and eliminates delivery risk from the transactions. The system can handle multiple requests simultaneously, and can act as a clearinghouse for currency lenders to find appropriate borrowers and receive fees accordingly. Each lender can evaluate individual credit situations and price accordingly.

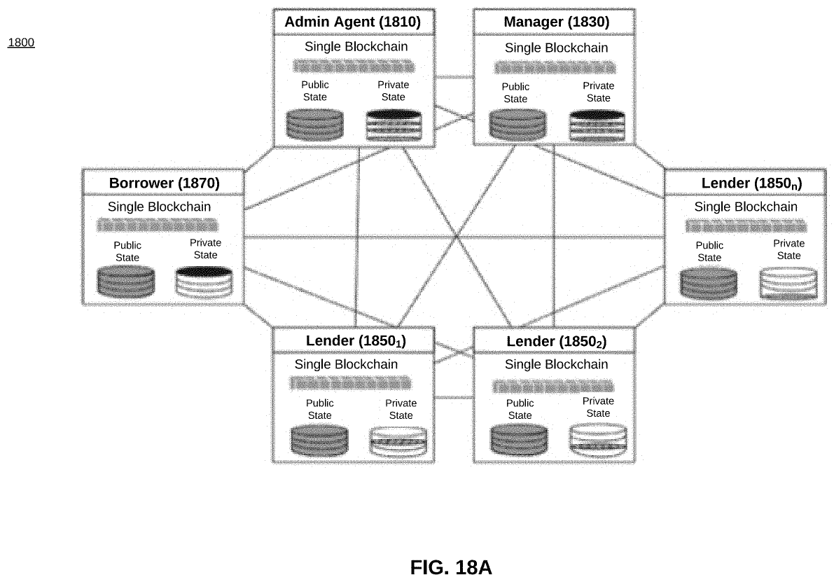

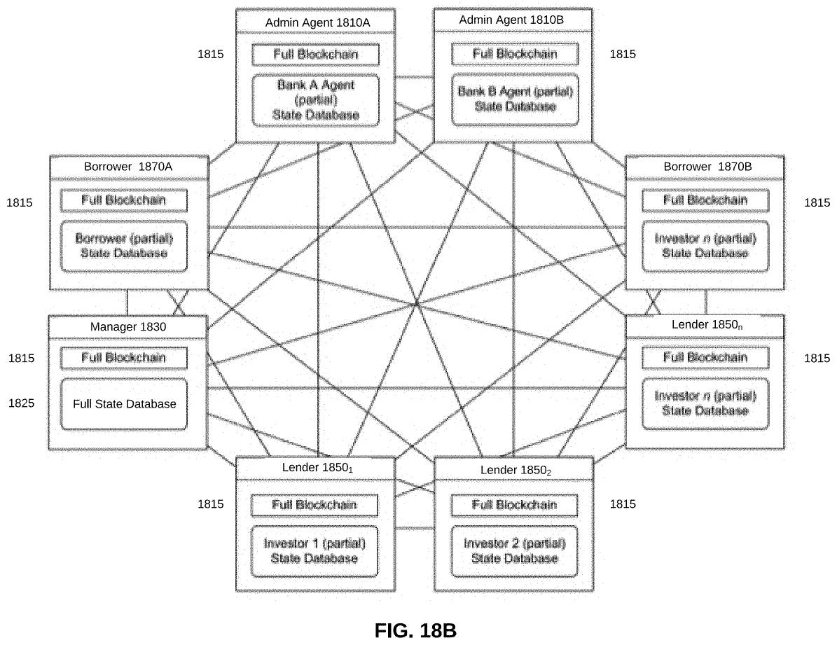

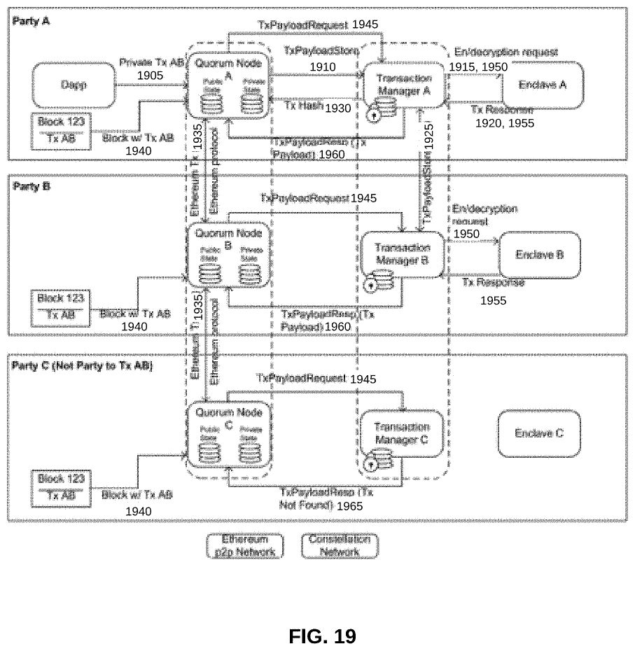

FIG. 18A, FIG. 18B, and FIG. 19 depict aspects of systems and process flows for transactions among borrowers and lenders in the exemplary context of a Quorum-based distributed ledger system in accordance with an embodiment. These depictions are exemplary, and are not intended to be limiting. Ordinarily skilled artisans will understand that other distributed ledger systems complying with the constraints described herein may be used.

FIG. 18A depicts a system 1800 for providing data privacy in a distributed ledger supporting smart contacts according to one embodiment. System 1800 may include nodes such as administrative (admin) agent 1810, manager 1830 (similar to manager 1050 in FIG. 1), lenders 1850₁, 1850₂, . . . 1850ₙ, and borrower 1870. Admin agent 1810, which may be optional, may be responsible for loan administration, and so may be a party to all (private) transactions. Manager 1830 may also be a party to all (private) transactions as it is responsible for overall oversight. Borrower 1870 may be a taker or a maker, and may be party to all transactions involving loans with the lender with which borrower 1870 is doing business. Lenders 1850₁, 1850₂, . . . 1850ₙ may provide funds to borrower 1870 through (private) transactions with borrower 1870 and manager 1830, and where applicable, with admin agent 1810. Lenders 1850₁, 1850₂, . . . 1850ₙ may not process the private transactions involving other lenders 1850₁, 1850₂, . . . 1850ₙ.

FIG. 18B depicts other aspects of the blockchain resources to which parties to an FX transaction may have access. FIG. 18B shows multiple administrative agents 1810A, 1810B and multiple borrowers 1870A, 1870B. Administrative agents 1810A and 1810B, and manager 1830 may maintain a full copy of distributed ledger 1815, and each may maintain a full state database 1825. The full copy of the distributed ledger 1815 may contain transactions with encrypted or unencrypted (e.g., hash digest) payloads. Alternatively, as shown in FIG. 18B, the administrative agents 1810, 1810B may have respective partial databases for the particular financial institutions corresponding to one or more lenders 1850₁, 1850₂, . . . 1850ₙ. The lenders 1850₁, 1850₂, . . . 1850ₙ, and borrower 1870 may also maintain a full copy of distributed ledger 1815 (which may contain encrypted or unencrypted (e.g., hash digest) transactions), but may maintain partial databases 1855 and 1875, corresponding to the private state databases in FIG. 18A, respectively, for the node. Thus, lenders 1850₁, 1850₂, . . . 1850ₙ, and borrower 1870 may only have access to state information that is relevant to them (e.g., if they are a party to a transaction).

FIG. 19 is a block diagram of a method for providing data privacy in a private distributed ledger supporting smart contacts according to an embodiment. In FIG. 19, Party A and Party B participate in the transaction at issue, but Party C does not. Consequently, as will be seen, Party C receives different notifications and information from Party A or Party B.

At 1905, a distributed application may prepare a transaction payload record for a private transaction between Party A and Party B to Node A. At 1910, Node A sends the TxPayload to Transaction Manager A for storage. At 1915, Transaction Manager A may send an encryption request to Enclave A, and, at 1920, may receive a response. At 1925, Transaction Manager A communicates with Transaction Manager B to send encrypted TxPayloadStore.

At 1930, Transaction Manager A sends a hash of TxPayloadStore to Node A. At 1935, Node A sends the pending transaction with the transaction hash payload to Node B and to Node C. At 1940, the block containing the transaction is written to the distributed ledgers.

At 1945, during the validation of the proposed block 123 which includes processing transaction AB, Node A sends TxPayloadRequest to Transaction Manager A, Node B sends TxPayloadRequest to Transaction Manager B, and Node C sends TxPayloadRequest to Transaction Manager C. At 1950, Transaction Manager A and Transaction Manager B request decryption from their respective enclaves, and, at 1955, the response is received. At 1960, Transaction Manager A and Transaction Manager B provide the TxPayload to their respective Nodes, which are parties to the transaction.

Here, it should be noted that Party C, which is not a party to the transaction, is not in the list of the recipients, and cannot receive the encrypted payload in response to TxPayloadRequest. Thus, at 1965, Party C receives a notification that the transaction was not found, that the transaction is private, or any other suitable notification.

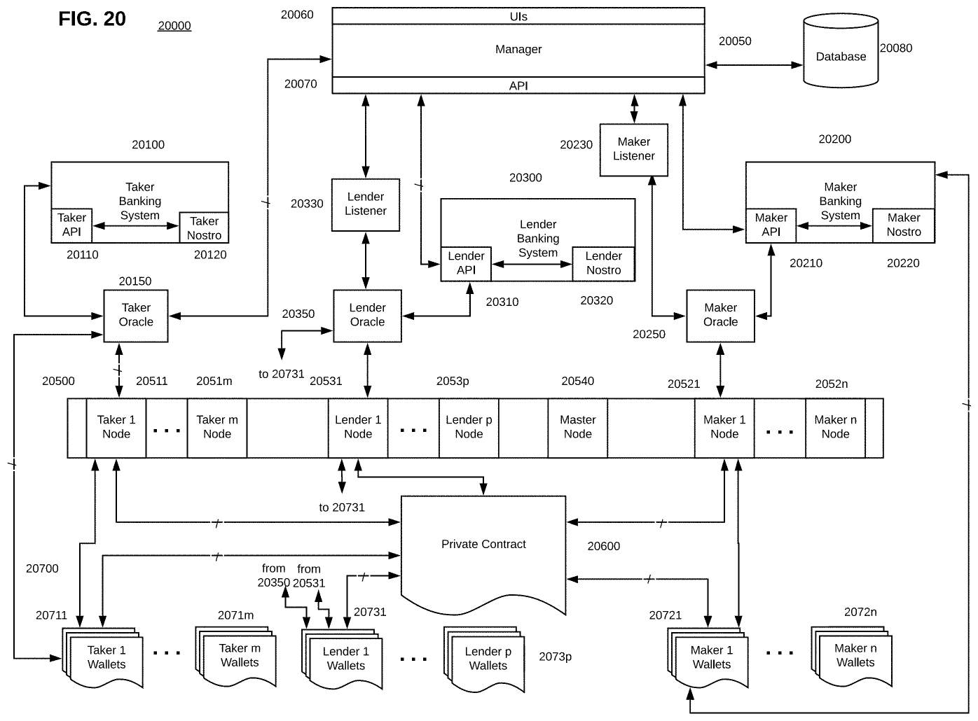

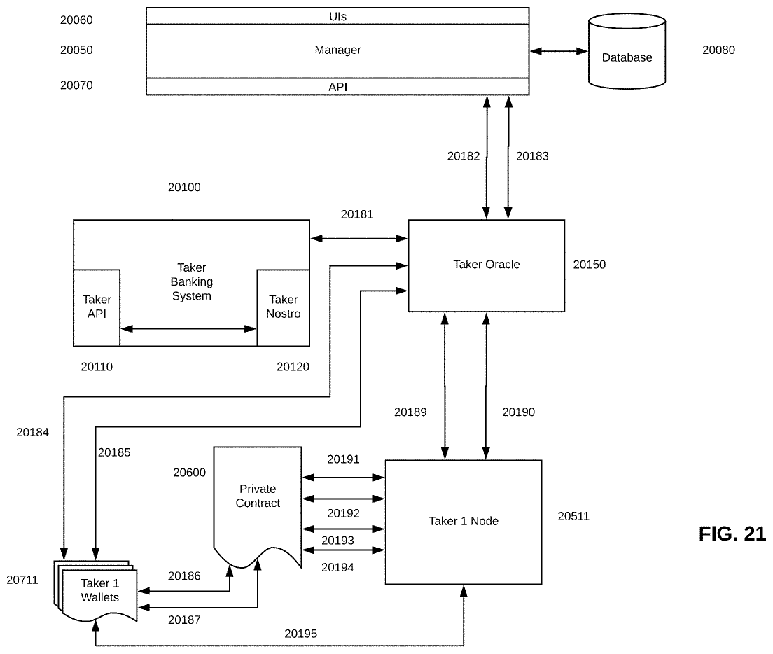

FIG. 20 depicts a number of connections and interactions among a number of elements, as will be discussed in more detail below with respect to FIG. 20 and also with respect to FIGS. 21-23, which break out taker-specific, maker-specific, and lender-specific interactions, respectively.

In FIG. 20, blockchain 20500 is shown as having a plurality of taker nodes 20511 to 2051m, a plurality of maker nodes 20521 to 2052n, a plurality of lender nodes 20531 to 2053p, and a master node 20540. The master node 20540 can act as an administrator. In various places in this description, the master node may be referred to as an “admin,” or as an “admin/master”.

Ordinarily skilled artisans will appreciate that, in a given blockchain system according to an embodiment, there may, and usually will be a plurality of takers, a plurality of makers, and a plurality of lenders. A taker in a given transaction may be a maker in a subsequent transaction. A lender may interact with either a taker or a maker. To provide an understanding of the consummation of transactions in the system of FIG. 20 without overly complicating the diagram, the following discussion will focus on a single taker, a single maker, and a single lender, it being understood that a lender may not be necessary to a given transaction.

Also in FIG. 20, a number of the lines between elements are shown with a slash through them, indicating multiple lines. These will be broken out in more detail in FIGS. 21-23.

Manager 20050 is a piece of hardware that enables interaction with takers, makers, and lenders through a plurality of user interfaces (UIs) 20060. In one aspect, a UI with takers may show trade offers (intents to enter transactions), trade creation, trade status, and transaction history. Where applicable, the UI also may show the taker's outstanding loans and balances, and loan history, as well as providing access to loan records for the taker. A UI with makers may show potential trades (including intent to enter into a particular trade), trade status, and transaction history. Where applicable, the UI also may show the maker's outstanding loans and balances, and loan history, as well as providing access to loan records for the maker. A UI with a given lender may show lender positions with borrowers (which could be takers or makers), lender terms, agreements with borrowers, outstanding loans, and loan history, as well as providing access to any loan records.

In one aspect, either separately from or as part of either the taker UI or the maker UI, there may be a UI for a borrower generally, reflecting loan offers, loan acceptances, outstanding loans, loan repayment, and loan history, among other things. Accordingly, where a lender gets involved in funding, or in bidding to fund a given transaction, depending on who the borrower is (here, either the taker or the maker), a UI with the borrower may show, for that borrower, loan offers that the borrower has received; loan acceptances that the borrower has made; outstanding loans to the borrower; loan repayments that the borrower has made; and loan history.

In all of the foregoing, information on completed trades and loans will reflect the parties to the trades, and the borrowers and lenders where applicable.

When FX transactions occur according to aspects of the present invention, they can close quickly, because the transactions (for example, FX trades) are funded before they are consummated. The speed of transaction consummation is not necessarily related to timing of loan repayments where loans are involved. A borrower may repay a lender immediately, and then engage in another FX transaction shortly thereafter while taking another loan; the borrower may roll over the loan into a subsequent transaction; or the borrower may aggregate loans over the course of a period of time. The mechanisms for carrying out each of these scenarios may vary, but such variances do not affect the overall availability of on-demand payment liquidity in accordance with aspects of the invention.

An additional UI that may be part of the UIs 20060 would be an administrator UI, accessible by the entity or entities responsible for operation of manager 20050. The administrator UI may have one or more screens to display any or all of the information displayed in any of the UIs discussed earlier. In one aspect, the administrator UI also may display management-related items, including items relating to overall financial performance, fees received, transaction history and the like. The administrator UI also may access elements of one or more applications within manager 20050, including a master library of clients (takers, makers, lenders), potential clients, transactions, pending transactions, and other possibly relevant data for effecting transactions. There also may be access to a manager and/or cache for current, pending, and/or recent transactions, as well as an ability to access and, where appropriate or applicable, manage and/or edit a set of rules governing behavior on blockchain 20500.

In one aspect, manager 20050 works with various banks, lenders, and other financial institutions via a plurality of application programming interfaces (APIs) 20070.

In an embodiment, in conjunction with manager 20050 there may be a database 20080 (FIG. 25) which may house a log of transactions, an orderbook listing orders for transactions, a log of loans which have been made, pending lending transactions, user profiles, and auditing and logging rules and practices. The above-referenced master library may be housed in manager 20050, or it may be housed within database 20080. Contents of the above-referenced cache also may reside in database 20080, or may be transferred automatically to database 20080 after a period of time, depending on the rules for the cache and the size of the cache, among other things. Ordinarily skilled artisans will understand well how to relate the cache to the database 20080 to effect appropriate operation of the manager 20050 within the overall system 20000.

In one aspect, each of the taker, the maker, and the lender will have recourse to a system regulating access to funds. For consistency of description, in FIG. 20 these systems are referred to as banking systems, but it should be understood that “banking” here is intended to refer merely to a source of funds, and not to a banking institution in the strictest sense.

One aspect of the present invention is that, while financial institutions such as banks, lending institutions, and other such institutions all over the world each may tend to have a unique or at least somewhat different application programming interface (API), the inventive system which facilitates the various kinds of financial transactions described here is intended to work with any and all of those APIs. In an embodiment, the inventive system will have a single API with which these various financial institutions can interface. The system may provide multiple APIs, but ordinarily skilled artisans will appreciate that the larger the number of APIs that the system provides, the more cumbersome the management will tend to be. Additionally, from a regulatory or merely an efficiency perspective, as FX and other types of transactions involving financial instruments, securities, and the like are set up to execute on a blockchain network, it may be desirable to standardize an API for a particular type of transaction.

FIG. 21 presents a slightly more detailed view of a portion of FIG. 20, focusing on system architecture and structure relating to the taker. FIG. 21 uses the same reference numerals in FIG. 20 wherever possible, for consistency of description. One difference between FIG. 20 and FIG. 21 is that the lines in FIG. 20 that had a slash through them, to denote multiple lines, appear in FIG. 21 as multiple lines.

Looking more closely at FIG. 21, taker banking system 20100 communicates with taker oracle 20150 over communication line 20181. Associated with taker banking system 20100 is a taker API (application programming interface) 20110 and a taker nostro 20120. The taker nostro 20120 identifies, for a particular taker, where that taker's funds in the currency of interest may be located (e.g. which financial institution). The taker oracle 20150 may access a data library, such as the above-referenced master library, which may be within manager 20050, or may be within database 20080. Taker oracle 20150 provides a trusted source of data to the blockchain, in particular, in one aspect, to taker node 20511. Among other things, over communication line 20181 taker oracle 20150 can request validation of funds availability, and locking or freezing of funds for a particular trade, from taker banking system 20100. In turn, taker banking system 20100 can confirm funds availability, and can confirm locking or freezing of funds for the trade.

Taker oracle 20150 communicates with manager 20050 over communication lines 20182 and 20183. In one aspect, communication line 20183 is associated with communication with a lender. Among other things, over these lines, manager 20050 and taker oracle 20150 can communicate about funds availability and freezing/locking of funds.

Taker oracle 20150 also communicates with taker 1 wallet 20711 over communication lines 20184 and 20185. In one aspect, communication line 20185 may be associated with communication with a lender. Among other things, along these lines the minting of tokens for completing the taker's portion of trade on the blockchain may be carried out, as well as the freezing or locking of funds associated with those tokens until the trade is carried out. The taker wallet 20711 may acknowledge payment through completion of the private contract 20600. In this connection, taker 1 wallet 20711 may communicate with one or more portions of private contract 20600 over communication lines 20186 and 20187. In one aspect, communication line 20187 may be associated with communication with a lender. Taker wallet 20711 also may receive an instruction to burn the taker's received tokens after the transaction is complete. Upon burning the tokens, taker wallet 20711 can provide confirmation of the burning to taker oracle 20150. In addition, taker oracle 20150 communicates with taker 1 node 20511 over communication lines 20189 and 20190. In one aspect, communication line 20189 may be associated with communication with a lender. Over these lines 20189 and 20190, taker oracle 20150 is able to submit a private transaction to the blockchain.

Taker 1 node 20511 communicates with various portions of private contract 20600 (FIG. 5) over communication lines 20191, 20192, 20193, and 20194. In one aspect, communication lines 20191 and 20193 may be associated with communication with a lender. Taker 1 node 20511 also communicates with taker 1 wallet 20711 over communication line 20195. Among other things, these communications promote recording of events on the blockchain.

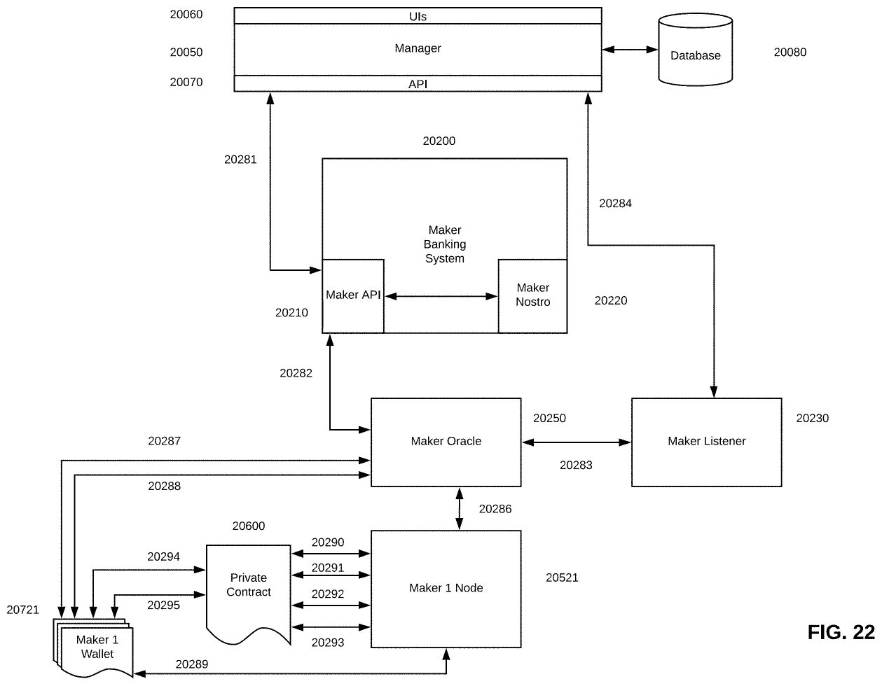

FIG. 22 presents a slightly more detailed view of a portion of FIG. 20, focusing on system architecture and structure relating to the maker. FIG. 22 uses the same reference numerals in FIG. 20 wherever possible, for consistency of description. One difference between FIG. 20 and FIG. 22 is that the lines in FIG. 20 that had a slash through them, to denote multiple lines, appear in FIG. 22 as multiple lines. In FIG. 22, maker banking system 20200 communicates information relating to maker feeds (which in one aspect may be data relating to potential transactions with one or more takers) and to a bid/ask feed (which in one aspect provides information relating to a spread between a bidding price and an asking price for a particular transaction) with manager 20050 over communication line 20281.

Associated with maker banking system 20200 is a maker API (application programming interface) 20210 and a maker nostro 20220. The maker nostro 20220 identifies, for a particular maker, where that maker's funds in the currency of interest may be located (e.g. which financial institution). Maker banking system 20200 communicates with maker oracle 20250 over communication line 20282. The maker oracle 20250 may access a data library, such as the above-referenced master library, which may be within manager 20050, or may be within database 20080. Maker oracle 20250 provides a trusted source of data to the blockchain, in particular, in one aspect, to maker node 20521. Among other things, over communication line 20282 maker oracle 20250 can request validation of funds availability, and locking or freezing of funds for a particular trade, from maker banking system 20200. In turn, maker banking system 20200 can confirm funds availability, and can confirm locking or freezing of funds for the trade.

In an embodiment, maker oracle 20250 may communicate with maker listener 20230 over communication line 20283. Maker listener 20230 in turn may communicate with manager 20050 over communication line 20284. Where the maker associated with maker listener 20230 enters into a transaction with a taker, the maker listener 20230 may enable provision of a countersignature for the transaction, at the same time as, or very closely in time with the taker's completion.

In certain applications, such as those involving ERC-20 (Airswap) smart contracts, maker listener 20230 may be useful. In other applications, such as those involving a zero-knowledge security layer, or ZSL, maker listener 20230 may not be necessary, as the transaction between maker and taker can occur on the blockchain.

Maker oracle 20250 may communicate with maker 1 node 20521 over communication line 20286. Communications between maker oracle 20250 and maker 1 node 20521 may include, among other things, acknowledgements from the maker node 20521, including an address of the maker node 20521. Maker oracle 20250 also may communicate with maker 1 wallet 20721 over communication lines 20287 and 20288. In one aspect, communication line 20287 may be associated with communication with a lender.

Among other things, along these lines the minting of tokens for completing the taker's portion of trade on the blockchain may be carried out, as well as the freezing or locking of funds associated with those tokens until the trade is carried out. The maker wallet 20721 may acknowledge payment through completion of the private contract 20600. Maker wallet 20721 also may receive an instruction to burn the maker's received tokens after the transaction is complete. Upon burning the tokens, maker wallet 20721 can provide confirmation of the burning to maker oracle 20150. Maker 1 node 20521 also may communicate with private contract 20600 over communication lines 20290-20293. In one aspect, communication lines 20291 and 20293 are associated with a lender. Maker 1 node 20521 also may communicate with maker 1 wallet 20721 over communication line 20289. Among other things, these communications promote recording of events on the blockchain.

Private contract 20600 may communicate payment information with maker 1 wallet over communication lines 20294 and 20295. In one aspect, communication line 20295 may be associated with communication with a lender.

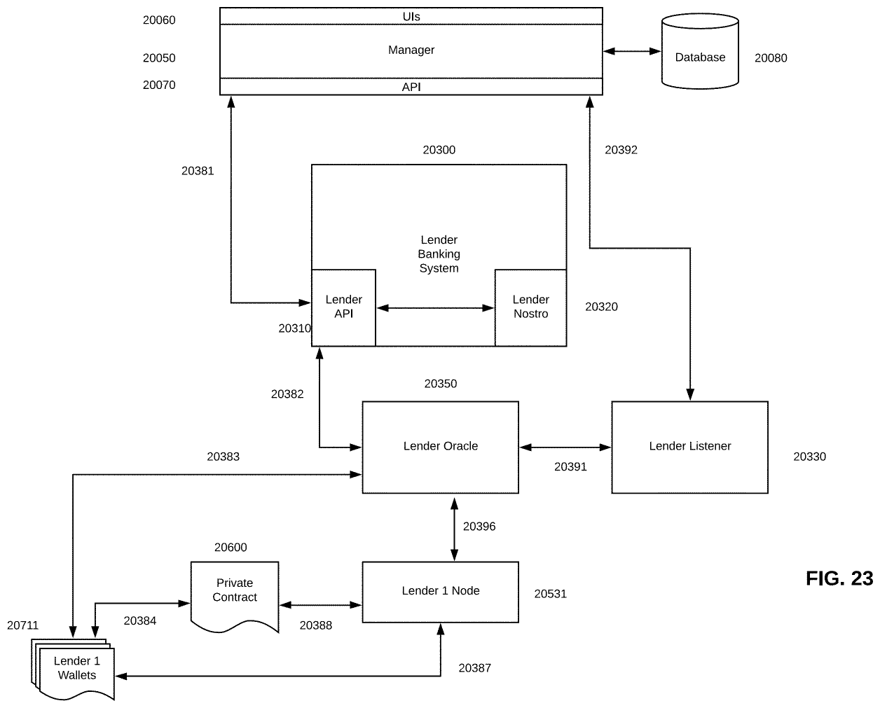

FIG. 23 presents a slightly more detailed view of FIG. 20, focusing on system architecture and structure relating to the lender. FIG. 23 uses the same reference numerals in FIG. 20 wherever possible, for consistency of description. In FIG. 23, lender banking system 20300 communicates with manager 20050 over communication line 20381. Among other things, communication line 20381 may convey information about lender feeds, and credit positions (e.g. credit histories and current credit information) of entities that might request a loan for a transaction. Lender banking system 20300 also communicates with lender oracle 20350, over communication line 20382.

Associated with lender banking system 20300 is a lender API (application programming interface) 20310 and a lender nostro 20320. The lender nostro 20320 identifies, for a particular lender, where that lender's funds in the currency of interest may be located (e.g. which financial institution). The lender oracle 20350 may access a data library, such as the above-referenced master library, which may be within manager 20050, or may be within database 20080. Lender oracle 20350 provides a trusted source of data to the blockchain, in particular, in one aspect, to lender node 20531 over communication line 20396. In turn, lender banking system 20300 can confirm funds availability, and can confirm locking or freezing of funds for the trade.

In an embodiment, lender oracle 20350 may communicate with lender 20330 over communication line 20391. Lender listener 20330 may communicate in turn with manager 20050 over communication line 20392. Among other things, communication line 20392 may convey a signed trade object, so that manager 20050 is aware of the status.

Where the lender associated with lender listener 20330 enters into a loan transaction with either a taker or a maker, the lender listener 20330 may enable provision of a countersignature for the transaction at the same time as, or very closely in time with the taker's or the maker's completion.

In certain applications, such as those involving ERC-20 (Airswap) smart contracts, lender listener 20330 may be useful. In other applications, such as those involving a zero-knowledge security layer, or ZSL, lender listener 20330 may not be necessary, as the transaction between the lender and either the maker or the taker can occur on the blockchain.

Lender oracle 20350 also communicates with lender 1 wallet 20711 via communication line 20383. Among other things communicated along this communication line is information about minting and burning of tokens, and locking of funds for the transaction to be completed. This communication line also may convey payment acknowledgement via a z-contract that is part of private contract 20600.

Lender 1 node 20531 communicates with lender 1 wallet 20711 over communication line 20387. Lender 1 node 20531 also communicates with private contract 20600 over communication line 20388. Among other things, these communications promote recording of events on the blockchain.

In one aspect, the various communications with manager 20050 as depicted in FIGS. 20-23 may be as part of a common data services facility at manager 20050.

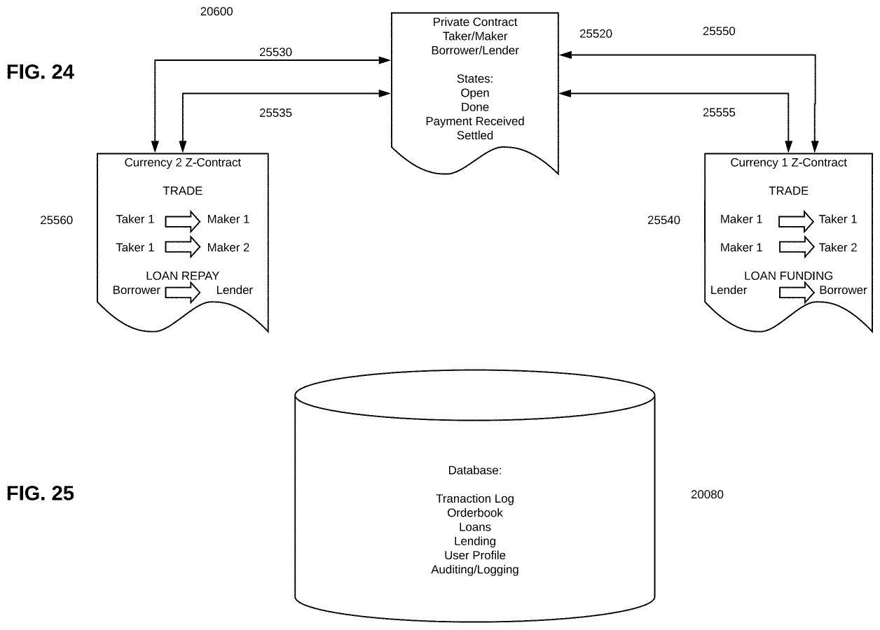

FIG. 24 shows additional detail regarding private contract 20600 in FIG. 20. In particular, FIG. 24 depicts aspects of smart contracts known as z-contracts. As noted earlier, a smart contract is not so much a contract as it is a piece of code that will execute on its own when certain specified conditions are met. In FIG. 24, in one portion of the code constituting private contract 20600, there may be a private contract 25520 between a taker and a maker, or between a lender and a borrower (in which the borrower may be either a taker or a maker). The states set forth in this code may include: i) open (meaning that the contract associated with the code is not yet completed); ii) done (meaning that the contract is completed); iii) payment received (advising that one party or another, or both, have received payment for their parts of the agreement or contract); and iv) settled (meaning that the funds that are to have changed hands have settled).

One or more z-contracts 25540, 25560 may be associated with private contract 25520 as part of overall private contract 20600. Z-contract 25540 may communicate with the code for private contract 25520 over communication lines 25530, 25535. In one aspect, communication line 25535 is associated with communication with, or some aspect of a transaction with a lender. In one aspect, Z-contract 25540 is associated with one of the currencies to be traded (referred to as Currency 1). The Z-contract 25540 may contain terms for one or more trades between Maker 1 and either Taker 1, or Taker 2, or both. That is, Maker 1 may identify two potential transactions, one with Taker 1 and one with Taker 2. If there is a loan associated with the transaction, Z-contract 25540 may be set for funding of the loan, from a lender to a borrower.

Z-contract 25560 may communicate with the code for private contract 25520 over communication lines 25550, 25555. In one aspect, communication line 25555 is associated with communication with, or some aspect of a transaction with a lender. In one aspect, Z-contract 25560 is associated with one of the currencies to be traded (referred to as Currency 2). The Z-contract 25560 may contain terms for one or more trades between Taker 1 and either Maker 1, or Maker 2, or both. That is, Taker 1 may have opportunities for executing a desired trade, and may identify two such transactions, one with Maker 1 and one with Maker 2. If there is a loan associated with the transaction, Z-contract 25540 may be set for repayment of the loan, from a borrower to a lender.

In one aspect, one or more smart contracts that form part or all of private contract 20600 may be in accordance with a technical standard known as ERC-20.

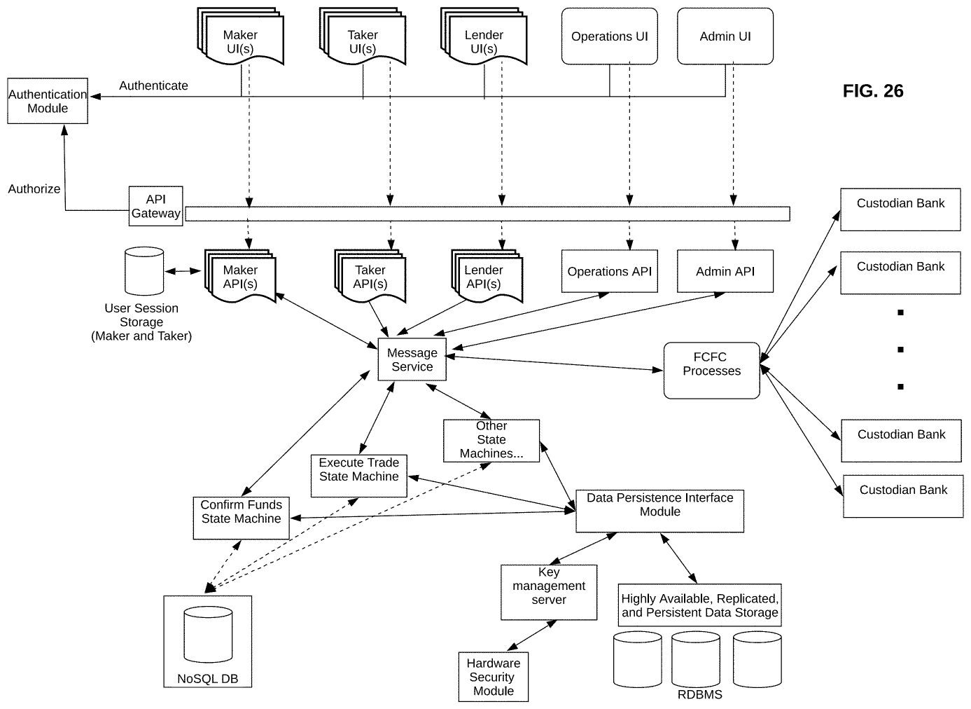

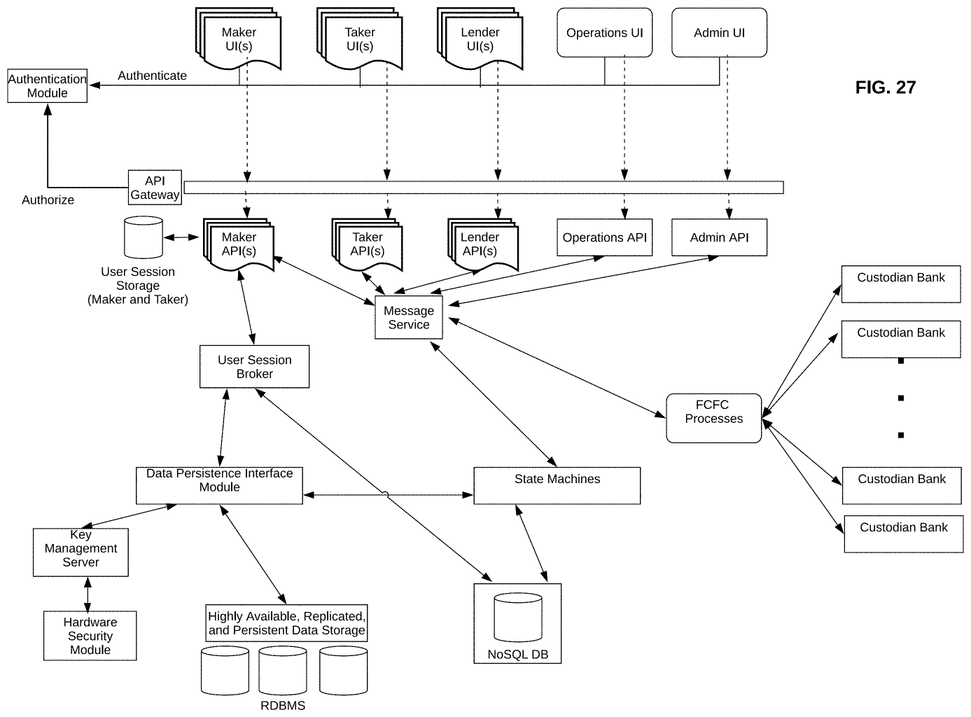

In the foregoing embodiments, blockchain as an embodiment of distributed ledger technology is integral to security and risk elimination. In some circumstances, another type of distributed ledger technology structure, including a highly available, replicated, persistent data storage system, operating with a consensus mechanism, may be an alternative. FIGS. 26 and 27 show embodiments of such an alternative system. Before describing these embodiments, the following discussion, similar to earlier discussion of blockchain embodiments, provides some context.

Between the use of cryptography and the distribution of the ledger, the likelihood of hacking the highly available, replicated, persistent data storage system to disrupt, reorder, or otherwise alter any of the nodes in the storage system becomes very low. This low probability exists, at least in part, because the ledger of transactions does not reside only with a single third party, but instead resides in the nodes in the storage system. The nodes may operate according to a consensus mechanism to ratify transactions. With some consensus mechanisms, such as Istanbul Byzantine Fault Tolerant (IBFT), participants arrive at a mutual agreement. A system operating with IBFT can continue to function properly even if some nodes are dishonest. With other consensus mechanisms, such as RAFT, participants trust a leader. Not surprisingly, because there is no need for agreement among participants, RAFT tends to work faster than IBFT. In a closed system, it can tend to be less likely that participants will take over, because participants are there by invitation and have their activities circumscribed.

For security reasons, a highly available, replicated, persistent data storage system generally does not have a way of accessing information outside of itself. Such a restriction is important for the integrity of transactions on the storage system. In order for the storage system to acquire information, the system needs a trusted external source that supplies data to the distributed ledger system. In general, the trusted source finds and verifies data and transmits that data to the distributed ledger system. In one context, a trusted source may be thought of as a layer that interfaces with both data sources and with the distributed ledger system. In this sense, a trusted source transfers and translates data from outside the distributed ledger, onto the distributed ledger. According to embodiments, there may be multiple trusted sources providing data to the distributed ledger.

A highly available, replicated, persistent data storage system may contain pieces of self-executing code known in blockchain parlance as smart contracts. Smart contracts may be self-executing in that, in response to receipt of certain data, certain functions may be carried out. For example, in the case of an FX transaction, a smart contract may contain code regarding conditions for funding of the transaction. When the smart contract receives inputs indicating that those conditions are met, the smart contract may allow the transaction to proceed. In one aspect, those inputs come from the one or more data persistence interface modules. According to embodiments, for a given FX transaction, there may be multiple smart contracts that execute.

A trusted source in accordance with an embodiment generally coordinates transaction portions which are to be carried out outside of the highly available, replicated, persistent data storage system. For example, the matching of a taker (a party seeking to initiate a transaction) and a maker (a party seeking to participate in the transaction with the taker) may occur outside of the highly available, replicated, persistent data storage system. In a situation in which a taker, or a maker, or both, lacks funds to complete the transaction, identification and selection of one or more lenders to enable funding of the transaction prior to its execution also may occur outside of the storage system. In one aspect, as a trusted source, the data persistence interface module will contain logic for handling and routing of information, and will provide an interface between involved financial institutions and the highly available, replicated, persistent data storage system.

In one aspect, one or more of the data persistence interface modules in the system described herein may incorporate machine learning, in the form of a neural network or other machine learning structure. The nature and volume of financial transactions that will be carried out will produce a substantial amount of non-user specific data which can be mined to obtain insights into when and how transactions are carried out, including not only such things as timing and periodicity of different types of transactions, but also quantities of transactions.

In one aspect, the distributed ledger technology system disclosed herein may be a highly available, replicated, persistent data storage system, operating with a consensus mechanism. An example of such a consensus mechanism would be directed acyclic graphs (DAG). Other consensus mechanisms, perhaps discussed more in the context of blockchain as a specific type of distributed ledger technology, could include consensus mechanisms in the Byzantine Fault Tolerance (BFT) family, for example, Istanbul Byzantine Fault Tolerance (IBFT). Ordinarily skilled artisans will appreciate that other types of consensus mechanisms, such as proof of work (PoW), proof of stake (PoS), or proof of authority (PoA), may be used in a distributed ledger technology system. Those artisans also will appreciate that latency, computational intensity, and other potential tradeoffs may militate in favor of one consensus mechanism over another. Another example, in the context of more centralized management of distributed ledger systems, is RAFT. In a more centralized system, the leader may be the only one with direct access to the system, and the only one with a copy of the system. Irrespective of whether a system participant was part of a transaction, that participant will have a copy. Instead, the leader may provide specific transaction details to appropriate parties regarding any particular transaction. Consequently, parties to a particular transaction, and other entities (if any) which are entitled to see the transaction, will be able to see transaction details, for which they will have copies. Other entities on the distributed ledger system, which are not entitled to see details of the transaction, will have copies of the transaction as well, but only in encrypted form, for example, as a cryptographic hash. In one aspect, because a cryptographic hash is a unique representation of data, the stored cryptographic hash at each node that is not entitled to see details of the transaction can be compared readily to the transaction details to verify the accuracy of the details. As far as the consensus protocol for verifying that the transaction has taken place, the hash will provide that necessary verification. Receipt of that hash at the nodes will enable provision of that consensus.

In accordance with aspects of the present invention, another way of looking at distributed ledger technology is as a peer-to-peer network, enabling payments directly between counterparties, and obviating the need for a central clearinghouse. This kind of arrangement requires and enables payments to be made outside of normal business hours; the immutability of data stored on the distributed ledger system in accordance with aspects of the present invention yields lower risk and much more efficient operation compared with the current framework.

Instructions passed via the distributed ledger network in accordance with aspects of the present invention will have the dual benefit of being pre-confirmed for funding and being unable to be changed, thus preventing double utilization of funds.

Conducting transactions via a distributed ledger system in accordance with aspects of the present invention will engender substantially immediate payment by both parties (taker and maker) once they agree on a price. Both parties will have to be funded, either on their own or via a participating lender. Therefore, prior to showing a deal-eligible quote, both parties will have to demonstrate, via the distributed ledger system, that they have the requisite currencies to deliver. Establishment of adequate funding is one aspect of what enables smart contracts to self-execute.

In one aspect, the distributed ledger system may have a relatively small number of nodes, hosted by an admin, or leader, or master. Takers, makers, and lenders will pass through the admin/master in order to get access to the distributed ledger. In another aspect, the distributed ledger may have a plurality of nodes for takers, makers, and lenders, as well as a master node. As an example, there may be one node for each taker, maker, and lender. As another example, there could be fewer nodes than takers, or makers, or lenders. In this event, some of these participants may go through the admin/master to access the distributed ledger. Alternatively, ordinarily skilled artisans will appreciate that a taker in one transaction may be a maker in another. Different participants may fulfill different roles, either while accessing a single node, or while accessing the distributed ledger through the admin/master. Ordinarily skilled artisans will appreciate that, in a given system according to an embodiment, there may, and usually will be a plurality of takers, a plurality of makers, and a plurality of lenders. In addition, a taker to one transaction may be a maker in a subsequent transaction. A lender may interact with either a taker or a maker, or in some cases with both.

As an exemplary description of highly available, replicated, persistent data storage, U.S. Pat. No. 10,216,949 is incorporated herein by reference.

As ordinarily skilled artisans will appreciate, and as discussed previously, highly available, replicated, persistent data storage handling transactions of the type described herein will have its nodes operate according to a consensus mechanism. RAFT will be known to ordinarily skilled artisans, and so will not be described further here. IBFT is one of a family of consensus mechanisms known as Byzantine Fault Tolerant, or BFT, mechanisms. Ordinarily skilled artisans likewise have understandings of BFT, IBFT, and the like, and so those descriptions will not be repeated here.

RAFT is a more centralized consensus mechanism than IBFT. In some implementations, such as embodiments described herein having an operations UI and an admin UI to manage and administer some aspects of the operation, control may be more centralized. While increased centralization can make a single point of attack more likely, the trusted nature of the network, and the distributed ledger aspect in which hashes of records will be replicated and persistent, make hacking attempts unlikely to succeed. There will be a check to uncover unauthorized changes that arise.

FIG. 26 shows interaction with makers, takers and lenders through a plurality of user interfaces (UIs). There also is an admin UI, for administering aspects of the system in communication with the makers, takers, and lenders. The admin UI may have one or more screens to display any or all of the information displayed in any of the UIs discussed earlier. In one aspect, the admin UI also may display management-related items, including items relating to overall financial performance, fees received, transaction history and the like. The admin UI also may access elements of one or more applications, including a master library of clients (takers, makers, lenders), potential clients, transactions, pending transactions, and other possibly relevant data for effecting transactions.

There also is an operations UI, for operation of the overall system. In this UI, in some aspects, there may be access to a manager and/or cache for current, pending, and/or recent transactions, as well as an ability to access and, where appropriate or applicable, manage and/or edit a set of rules governing behavior in the distributed ledger system.

In one aspect, a UI for takers may show trade offers (intents to enter transactions), trade creation, trade status, and transaction history. Where applicable, the UI also may show the taker's outstanding loans and balances, and loan history, as well as providing access to loan records for the taker. A UI for makers shows potential trades, trade status, and transaction history. Where applicable, the UI also may show the maker's outstanding loans and balances, and loan history, as well as providing access to loan records for the maker. A UI with a given lender may show lender positions with borrowers (which could be takers or makers), lender terms, agreements with borrowers, outstanding loans, and loan history, as well as providing access to any loan records.

In one aspect, either separately from or as part of either the taker UI or the maker UI, there may be a UI for a borrower generally (not shown), reflecting loan offers, loan acceptances, outstanding loans, loan repayment, and loan history, among other things. Accordingly, where a lender gets involved in funding, or in bidding to fund a given transaction, depending on who the borrower is (here, either the taker or the maker), a UI with the borrower may show, for that borrower, loan offers that the borrower has received; loan acceptances that the borrower has made; outstanding loans to the borrower; loan repayments that the borrower has made; and loan history.

In one aspect, a system operator (which may be automated or human) may work with various banks, lenders, and other financial institutions via a plurality of application programming interfaces (APIs). One aspect of the present invention is that, while financial institutions such as banks, lending institutions, and other such institutions all over the world each may tend to have a unique or at least somewhat different application programming interface (API), the inventive system which facilitates the various kinds of financial transactions described here is intended to work with any and all of those APIs. In an embodiment, the inventive system will have a single API with which these various financial institutions can interface. In some aspects, the system may provide multiple APIs. From a regulatory or merely an efficiency perspective, as FX and other types of transactions involving financial instruments, securities, and the like are set up to execute on a distributed ledger network, it may be desirable to standardize an API for a particular type of transaction. However, in practice among financial institutions, most often all of the APIs will be different, tailored to individual institutional preferences. Accordingly, in an embodiment, a service such as Market Factory, which provides compatibility with APIs of multiple financial institutions, may be invoked. Using a service such as Market Factory can save having to come up with dozens of APIs (or more) for all of entities who may participate in transactions.

In an embodiment, there may be a database which may house a log of transactions, an orderbook listing orders for transactions, a log of loans which have been made, pending lending transactions, user profiles, and auditing and logging rules and practices. The above-referenced master library may be housed in such a database. Contents of the above-referenced cache also may reside in the database, or may be transferred automatically to the database after a period of time, depending on the rules for the cache and the size of the cache, among other things. Ordinarily skilled artisans will understand well how to relate the cache to the database to effect appropriate operation within the overall system.

In one aspect, each of the taker, the maker, and the lender will have recourse to a system regulating access to funds. For consistency of description, in FIG. 1 these systems are referred to as banking systems, but it should be understood that “banking” here is intended to refer merely to a source of funds, and not to a banking institution in the strictest sense.

Looking further at FIG. 1, the UIs and APIs connect through an API gateway. In an embodiment, that gateway may be implemented using Amazon API gateway. An authentication module enables users accessing the system through one of the UI to be authenticated. In an embodiment, the authentication module may be implemented using Amazon Cognito. Once a user is authenticated, authorization may be provided through the API gateway. In an embodiment, the authentication module needs to link with an actual user. As shown in FIG. 27, that linking may be effected by a user session broker.

According to embodiments, one or more custodian banks provide funds, in different currencies, to effect FX transactions. Depending on the situation, a single custodian bank may provide funds in more than one currency; multiple custodian banks may provide funds in the same currency; or each custodian bank may provide funds in a single currency. The availability of funds for FX transactions will be part of the input for FCFC processes, which will be discussed in more detail herein, but which are shown as a block in FIG. 1. It should be noted that the FCFC processes block appears outside of the distributed ledger in FIG. 1. However, certain aspects of those processes, for example, the FCFC themselves, will reside on the distributed ledger. Records of deposits and withdrawals, involving exchange of FCFC between takers and makers, will be recorded on the distributed ledger according to one aspect. Additionally, in one aspect initiation and execution of trades also will be recorded on the distributed ledger. Verification of balances also may be effected by accessing records on the distributed ledger. Finally, a loan contract between a lender and a borrower (taker or maker) may be preserved on the distributed ledger.

As noted earlier, the distributed ledger receives data from a trusted source, called a data persistence interface module. As FIG. 26 shows, the data persistence interface module communicates with the various state machines, shown separately in FIG. 26, but as a single entity in FIG. 27, which shows an alternative embodiment of the system in accordance with aspects of the invention. FIGS. 3-5, described previously, show the state machines. The state machines also communicate with central storage in the system. This is separate storage from the distributed ledger, and may contain not only records that are stored on the distributed ledger, but also additional records of various types as discussed herein.

Based on one or both of the UIs and smart contracts, the data persistence interface module may piece together details of a particular transaction, including identities (addresses) of a taker and a maker, currencies involved, and the amounts involved. The module sends the raw transaction to a key management server, which generates keys, signs raw data, and returns signed data. In the embodiments of FIGS. 26 and 27, key management is centralized. In other embodiments, each individual institution may manage its own key.

In the embodiments of FIGS. 26 and 27, as part of centralized key management, a hardware security module (HSM) is a physically separate device that generates private keys for encrypted transactions in accordance with an embodiment. System users (makers, takers, and lenders) use these private keys in this embodiment, instead of generating their own private keys. The HSM not only generates the private keys, but also retains them, hindering replication and/or hacking.

In order to be able to generate a key, a token first must be initialized. The data persistence interface module issues a request to the HSM, via the key management server, to do the initialization. Because the module is a trusted source, the HSM will perform the initialization. Next, a user PIN must be set. This request also comes to the HSM from the module via the key management server. Responsive to the request, the HSM will set the user PIN.

Next, the module will request the generation of a key. The HSM receives this request via the key management server, and generates the key. Finally, the module will request the HSM to sign the transaction. Once again, the request goes from the module to the HSM via the key management server. Responsive to raw transaction data from the module, the HSM hashes that data, signs the hash, and returns the signed hash.

One or more message services facilitates messaging communication between the various APIs, which as noted earlier play a role in authentication, with other parts of the system. In various embodiments, Amazon's Simple Notification Service (SNS) or Simple Queue Service (SQS) may provide the indicated messaging services. SNS pushes messages, while SQS queues them.

In an embodiment, takers will connect directly to a UI in the system and execute trades through that UI.

In an embodiment, a maker could be a person confirming a trade with a taker. Alternatively, a maker could employ an algorithm. Makers access the system to make trades available (i.e. to indicate interest in trades). In an embodiment, makers have their own UIs. In such a circumstance, use of a facility such as Market Factory can facilitate connecting more makers to the system.

In one aspect, ordinarily skilled artisans will appreciate that takers just want to look to see if there are trades they want to accept, so they may not/do not need or care about their own UI.

The foregoing description of FIG. 17, in the context of blockchain embodiments, also is applicable in the context of distributed ledger systems according to the embodiments of FIGS. 26 and 27.

The following clauses further describe and summarize aspects of the invention according to the foregoing description, as follows:

Clause 1. A system to effect accelerated foreign exchange (FX) transaction processing, the system including apparatus to effect the following:
responsive to a first indication from a first party of a desire to enter into a FX transaction, record the first indication in encrypted fashion in the system, and provide a first approval to the first party to engage in the FX transaction in response to satisfaction of first predetermined criteria which are communicated in encrypted fashion within the system; and
responsive to a second indication from a second party of a desire to enter into the FX transaction, record the second indication in encrypted fashion in the system, and provide a second approval to the second party to engage in the FX transaction in response to satisfaction of second predetermined criteria which are communicated in encrypted fashion within the system; and
record, in encrypted and immutable fashion, steps to effect the FX transaction;
wherein the system further comprises:
a first user interface (UI) and a first application programming interface (API) to enable the first party to communicate with the system;
a second UI and a second API to enable the second party to communicate with the system;
at least one state machine to manage the FX transaction in response to actions of the first party and the second party;
the first party to participate in the FX transaction by exchanging first tokens that are priced according to a first fiat currency, for second tokens that are priced according to a second fiat currency; and
the second party to participate in the FX transaction by exchanging the second tokens that are priced according to the second fiat currency, for the first tokens that are priced according to the first fiat currency;
wherein a value of the first tokens fluctuates only according to fluctuations in an underlying value of the first fiat currency, and a value of the second tokens fluctuates only according to fluctuations in an underlying value of the second fiat currency.
   Clause 2. A system according to Clause 1, wherein the state machine comprises apparatus to freeze funds of the first party sufficient to effect the FX transaction.
   Clause 3. A system according to Clause 1 or Clause 2, wherein the state machine comprises apparatus to freeze funds of the second party sufficient to effect the FX transaction.
   Clause 4. A system according to any of Clauses 1 to 3, wherein the state machine comprises apparatus to unfreeze the funds of the first party sufficient to effect the FX transaction.
   Clause 5. A system according to any of Clauses 1 to 4, wherein the state machine comprises apparatus to unfreeze the funds of the second party sufficient to effect the FX transaction.
   Clause 6. A system according to any of Clauses 1 to 5, further comprising apparatus to execute at least one smart contract, responsive to the satisfaction of the first and second predetermined criteria, to effect the FX transaction
   Clause 7. A system according to any of Clauses 1 to 6, wherein the system includes apparatus to disaggregate funding of an FX transaction from the FX transaction itself by prequalifying the funding in a secure and trusted manner.
   Clause 8. A system according to any of Clauses 1 to 7, wherein at least one of the first and second predetermined criteria includes agreement from at least one lender to provide funds in one of the first and second fiat currencies to one of the first party and the second party to prequalify one of the first party and the second party to engage in the FX transaction, the system further comprising a third UI and a third API to enable the at least one lender to provide at least some of the first tokens to the first party, or at least some of the second tokens to the second party.
   Clause 9. A system according to any of Clauses 1 to 8, wherein the first predetermined criteria include agreement from multiple lenders to provide a first required amount of funds in the first fiat currency, as at least some of the first tokens, to the first party to prequalify funding for the first party to engage in the FX transaction.
   Clause 10. A system according to any of Clauses 1 to 9, wherein the first required amount of funds consists of all of the funds that the first party will use to engage in the FX transaction.
   Clause 11. A system according to any of Clauses 1 to 10, wherein the second predetermined criteria include agreement from multiple lenders to provide a second required amount of funds in the second fiat currency, as at least some of the second tokens, to the second party to prequalify funding for the second party to engage in the FX transaction.
   Clause 12. A system according to any of Clauses 1 to 11, wherein the second required amount of funds consists of all of the funds that the second party will use to engage in the FX transaction.
   Clause 13. A system according to any of Clauses 1 to 12, further comprising a blockchain-on which the FX transaction is conducted.
   Clause 14. A system according to any of Clauses 1 to 13, further comprising an oracle to communicate data regarding the FX transaction with the blockchain.
   Clause 15. A system according to any of Clauses 1 to 12, further comprising a highly available, replicated, persistent data storage system on which the FX transaction is conducted.
   Clause 16. A system according to any of Clauses 1 to 13, further comprising a data persistence interface module to communicate data regarding the FX transaction with the highly available, replicated, persistent data storage system.
   Clause 17. A system according to any of Clauses 1 to 16, further comprising a security system to provide encryption for the first and second predetermined criteria, and to enable encrypted recording of the steps of the FX transaction.
   Clause 18. A system according to any of Clauses 1 to 17, wherein the security system comprises a key management server to manage private encryption keys, and a hardware security module to generate the private encryption keys to provide the encryption for the first and second predetermined criteria, and to enable encrypted recording of the steps of the FX transaction.
   Clause 19. A method to effect accelerated foreign exchange (FX) transaction processing, the method comprising:
responsive to a first indication from a first party of a desire to enter into a FX transaction, recording the first indication in encrypted fashion, and providing a first approval to the first party to engage in the FX transaction in response to satisfaction of first predetermined criteria which are communicated in encrypted fashion; and
responsive to a second indication from a second party of a desire to enter into the FX transaction, recording the second indication in encrypted fashion, and providing a second approval to the second party to engage in the FX transaction in response to satisfaction of second predetermined criteria which are communicated in encrypted fashion; and
recording, in encrypted and immutable fashion, steps to effect the FX transaction;
the method further comprising:
managing the FX transaction in response to actions of the first party and the second party;
the first party to participate in the FX transaction by exchanging first tokens that are priced according to a first fiat currency, for second tokens that are priced according to a second fiat currency; and
the second party to participate in the FX transaction by exchanging the second tokens that are priced according to the second fiat currency, for the first tokens that are priced according to the first fiat currency;
wherein a value of the first tokens fluctuates only according to fluctuations in an underlying value of the first fiat currency, and a value of the second tokens fluctuates only according to fluctuations in an underlying value of the second fiat currency.
   Clause 20. A method according to Clause 19, further comprising freezing funds of the first party sufficient to effect the FX transaction.
   Clause 21. A method according to Clause 19 or Clause 20, further comprising freezing funds of the second party sufficient to effect the FX transaction.
   Clause 22. A method according to any of Clauses 19 to 21, further comprising unfreezing the funds of the first party sufficient to effect the FX transaction.
   Clause 23. A method according to any of Clauses 19 to 22, further comprising unfreezing the funds of the second party sufficient to effect the FX transaction.
   Clause 24. A method according to any of Clauses 19 to 23, further comprising executing at least one smart contract, responsive to the satisfaction of the first and second predetermined criteria, to effect the FX transaction.
   Clause 25. A method according to any of Clauses 19 to 24, further comprising disaggregating funding of an FX transaction from the FX transaction itself by prequalifying the funding in a secure and trusted manner.
   Clause 26. A method according to any of Clauses 19 to 25, wherein at least one of the first and second predetermined criteria includes agreement from at least one lender to provide funds in one of the first and second fiat currencies to one of the first party and the second party to prequalify one of the first party and the second party to engage in the FX transaction, the at least one lender to provide at least some of the first tokens to the first party, or at least some of the second tokens to the second party.
   Clause 27. A method according to any of Clauses 19 to 26, wherein the first predetermined criteria include agreement from multiple lenders to provide a first required amount of funds in the first fiat currency, as at least some of the first tokens, to the first party to prequalify funding for the first party to engage in the FX transaction.
   Clause 28. A method according to any of Clauses 19 to 27, wherein the first required amount of funds consists of all of the funds that the first party will use to engage in the FX transaction.
   Clause 29. A method according to any of Clauses 19 to 28, wherein the second predetermined criteria include agreement from multiple lenders to provide a second required amount of funds in the second fiat currency, as at least some of the second tokens, to the second party to prequalify funding for the second party to engage in the FX transaction.
   Clause 30. A method according to any of Clauses 19 to 29, wherein the second required amount of funds consists of all of the funds that the second party will use to engage in the FX transaction.
   Clause 31. A method according to any of Clauses 19 to 30, further comprising conducting the FX transaction in a blockchain system.
   Clause 32. A method according to any of Clauses 19 to 31, further comprising communicating data regarding the FX transaction with the blockchain system.
   Clause 33. A method according to any of Clauses 19 to 32, further comprising conducting the FX transaction in a highly available, replicated, persistent data storage system.
   Clause 34. A method according to any of Clauses 19 to 33, further comprising communicating data regarding the FX transaction with the highly available, replicated, persistent data storage system.
   Clause 35. A method according to any of Clauses 19 to 34, further comprising providing encryption for the first and second predetermined criteria, and enabling encrypted recording of the steps of the FX transaction.
   Clause 36. A method according to any of Clauses 19 to 35, further comprising managing private encryption keys on a key management server, and generating the private encryption keys to provide the encryption for the first and second predetermined criteria, and to enable encrypted recording of the steps of the FX transaction, on a hardware security module.
   Clause 37. A blockchain-based system to effect accelerated transaction processing, wherein the transaction is selected from the group consisting of foreign exchange, over the counter derivatives, collateralized debt obligations, corporate bonds, commodities, and equities, wherein the blockchain-based system disaggregates the funding of the transaction from the transaction itself by prequalifying the funding in a secure and trusted manner.
   Clause 38. A blockchain-based system according to Clause 37, wherein the prequalifying the funding is carried out for all parties to the transaction.
   Clause 39. A blockchain-based system according to Clause 37 or 38, wherein the prequalifying of the funding comprises qualifying at least one of the parties for a loan.
   Clause 40. A blockchain-based system according to any of Clauses 37 to 39, wherein the system automates the prequalifying of the funding by secure communication of lending parameters on the blockchain, lenders and borrowers communicating on the blockchain to secure funding based on satisfaction of predetermined criteria.
   Clause 41. A blockchain-based system to effect accelerated foreign exchange (FX) transaction processing, wherein the blockchain-based system disaggregates funding of an FX transaction from the FX transaction itself by prequalifying the funding in a secure and trusted manner, the blockchain-based system including structure to effect the following:
responsive to a first indication from a first party (taker) of a desire to enter into a FX transaction, record the first indication in encrypted fashion in the system, and provide a first approval to the taker to engage in the FX transaction in response to satisfaction of first predetermined criteria which are communicated in encrypted fashion within the blockchain-based system; and
responsive to a second indication from a second party (maker) of a desire to enter into the FX transaction, record the second indication in encrypted fashion in the blockchain-based system, and provide a second approval to the maker to engage in the FX transaction in response to satisfaction of second predetermined criteria which are communicated in encrypted fashion within the blockchain-based system; and
record, in encrypted and immutable fashion, all steps in effecting the FX transaction;
wherein the system further comprises:
a taker oracle to facilitate communication of taker data, associated with the taker, from outside the blockchain to inside the blockchain in a trusted manner; and
a maker oracle to facilitate communication of maker data, associated with the maker, from outside the blockchain to inside the blockchain in a trusted manner.
   Clause 42. A blockchain-based system according to Clause 41, wherein one of the first and second predetermined criteria includes agreement from at least one lender to provide funds in one of first and second currencies to one of the taker and the maker to prequalify one of the taker and the maker to engage in the FX transaction, the system further comprising a lender oracle to facilitate communication of lender data, associated with the at least one lender, from outside the blockchain to inside the blockchain in a trusted manner.
   Clause 43. A blockchain-based system according to Clause 41 or 42, wherein the first predetermined criteria include agreement from multiple lenders to provide a first required amount of funds in a first currency to the taker to prequalify funding for the taker to engage in the FX transaction.
   Clause 44. A blockchain-based system according to any of Clauses 41 to 43, wherein the first required amount of funds consists of all of the funds that the taker will use to engage in the FX transaction.
   Clause 45. A blockchain-based system according to any of Clauses 41 to 44, wherein the first predetermined criteria include agreement from multiple lenders to provide a first required amount of funds in a first currency to the maker to prequalify funding for the maker to engage in the FX transaction.
   Clause 46. A blockchain-based system according to any of Clauses 41 to 45, wherein the first required amount of funds consists of all of the funds that the maker will use to engage in the FX transaction.
   Clause 47. A blockchain-based system according to any of Clauses 41 to 46, wherein the second predetermined criteria include agreement from a second lender to provide a second required amount of funds in a second currency to the taker to prequalify funding for the taker to engage in the FX transaction.
   Clause 48. A blockchain-based system according to any of Clauses 41 to 47, wherein the second required amount of funds consists of all of the funds that the taker will use to engage in the FX transaction.
   Clause 49. A blockchain-based system according to any of Clauses 41 to 48, wherein the second predetermined criteria include agreement from multiple lenders to provide a second required amount of funds in a second currency to the maker to prequalify funding for the maker to engage in the FX transaction.
   Clause 50. A blockchain-based system according to any of Clauses 41 to 49, wherein the second required amount of funds consists of all of the funds that the maker will use to engage in the FX transaction.
   Clause 51. A blockchain-based system according to any of Clauses 41 to 50, wherein the first predetermined criteria include agreement from at least a first lender to provide a first required amount of funds in a first currency to the taker to prequalify funding for the maker to engage in the FX transaction, and the second predetermined criteria include agreement from at least a second lender to provide a second required amount of funds in a second currency to the maker to prequalify funding for the maker to engage in the FX transaction.
   Clause 52. A blockchain-based system according to any of Clauses 41 to 51, wherein the first predetermined criteria include agreement from multiple lenders to provide a first required amount of funds in a first currency to the taker to prequalify funding for the taker to engage in the FX transaction.
   Clause 53. A blockchain-based system according to any of Clauses 41 to 52, wherein the first required amount of funds consists of all of the funds that the taker will use to engage in the FX transaction.
   Clause 54. A blockchain-based system according to any of Clauses 41 to 53, wherein the first predetermined criteria include agreement from multiple lenders to provide a first required amount of funds in a first currency to the maker to prequalify funding for the maker to engage in the FX transaction.
   Clause 55. A blockchain-based system according to any of Clauses 41 to 54, wherein the first required amount of funds consists of all of the funds that the maker will use to engage in the FX transaction.
   Clause 56. A blockchain-based system according to any of Clauses 41 to 55, wherein the second predetermined criteria include agreement from multiple lenders to provide a second required amount of funds in a second currency to the taker to prequalify funding for the maker to engage in the FX transaction.
   Clause 57. A blockchain-based system according to any of Clauses 41 to 56, wherein the second required amount of funds consists of all of the funds that the taker will use to engage in the FX transaction.
   Clause 58. A blockchain-based system according to any of Clauses 41 to 57, wherein the second predetermined criteria include agreement from multiple lenders to provide a second required amount of funds in a second currency to the maker to prequalify funding for the maker to engage in the FX transaction.
   Clause 59. A blockchain-based system according to any of Clauses 41 to 58, wherein the second required amount of funds consists of all of the funds that the maker will use to engage in the FX transaction.
   Clause 60. A blockchain-based system according to any of Clauses 41 to 59, wherein the first and second lenders are the same.
   Clause 61. A blockchain-based system to effect accelerated foreign exchange (FX) transaction processing, wherein the blockchain-based system disaggregates funding of an FX transaction from the FX transaction itself by prequalifying the funding in a secure and trusted manner, the blockchain-based system including structure to effect the following:
responsive to a first indication from a first party (taker) of a desire to enter into a FX transaction, record the first indication in encrypted fashion in the system, and provide a first approval to the taker to engage in the FX transaction in response to satisfaction of first predetermined criteria which are communicated in encrypted fashion within the blockchain-based system; and
responsive to a second indication from a second party (maker) of a desire to enter into the FX transaction, record the second indication in encrypted fashion in the blockchain-based system, and provide a second approval to the maker to engage in the FX transaction in response to satisfaction of second predetermined criteria which are communicated in encrypted fashion within the blockchain-based system; and
record, in encrypted and immutable fashion, all steps in effecting the FX transaction;
wherein the system further comprises:
a taker node to enable the taker to participate in the FX transaction by exchanging first tokens that are priced according to a first fiat currency, for second tokens that are priced according to a second fiat currency; and
a maker node to enable the maker to participate in the FX transaction by exchanging the second tokens that are priced according to the second fiat currency, for the first tokens that are priced according to the first fiat currency;
wherein a value of the first tokens fluctuates only according to fluctuations in an underlying value of the first fiat currency, and a value of the second tokens fluctuates only according to fluctuations in an underlying value of the second fiat currency.
   Clause 62. A blockchain-based system according to Clause 61, wherein one of the first and second predetermined criteria includes agreement from at least one lender to provide funds in one of the first and second fiat currencies to one of the taker and the maker to prequalify one of the taker and the maker to engage in the FX transaction, the system further comprising a lender node to enable the lender to provide first tokens to the taker, or second tokens to the maker.
   Clause 63. A blockchain-based system according to Clause 61 or 62, wherein the first predetermined criteria include agreement from multiple lenders to provide a first required amount of funds in the first fiat currency, as at least some of the first tokens, to the taker to prequalify funding for the taker to engage in the FX transaction.
   Clause 64. A blockchain-based system according to any of Clauses 61 to 63, wherein the first required amount of funds consists of all of the funds that the taker will use to engage in the FX transaction.
   Clause 65. A blockchain-based system according to any of Clauses 61 to 64, wherein the second predetermined criteria include agreement from multiple lenders to provide a second required amount of funds in the second fiat currency, as at least some of the second tokens, to the maker to prequalify funding for the maker to engage in the FX transaction.
   Clause 66. A blockchain-based system according to any of Clauses 61 to 65, wherein the second required amount of funds consists of all of the funds that the maker will use to engage in the FX transaction.

The foregoing embodiments are directed to a particular type of financial transaction, namely, foreign exchange. The invention is not so limited. Other types of financial institutions and financial transactions which can benefit from securitization of unsecured risk can benefit from aspects of the invention as described herein. Fundamentally, pre-funding of transactions to prevent naked short sales can speed processes up for numerous types of financial institutions engaged in numerous types of transactions. Examples of such financial institutions, as categories of participants who might prequalify to engage in such transactions include: Corporations/Treasury Functions; Asset Managers; Commercial Banks; Insurance Companies; Central Banks; Investment Banks; Hedge Funds; Investment Management Firms; Regional Banks; and Family Offices. In one aspect, any of these may be takers, makers, and/or lenders. Aspects of the invention also have applicability in markets for any or all of the following: Over the Counter (OTC) Derivatives (Caps, Collars, Floors, Swaps, Swaptions); Collateralized Debt Obligations (CDOs); Corporate Bonds; Commodities; or Equities.

In addition, according to aspects of embodiments disclosed herein, the availability of FCFC, particularly for lenders, may be attractive. Institutions with otherwise idle currency would like to find a way to put that currency to use to earn some kind of return. By leaving funds with a custodian bank, which makes the funds available within the system as FCFC, the owners of that currency can receive, for example, the overnight interest rate by leaving the currency in the system beyond the trading day.

Ordinarily skilled artisans will understand that some or all of the various elements of the embodiments described herein may be combined with each other, and that different combinations of those elements in some cases may omit some elements, but still constitute embodiments of the invention. Ordinarily skilled artisans also will understand that the various sequences described herein in accordance with embodiments may have varied orders of performance; may be combined with each other; or may have one or more steps omitted, but still constitute embodiments of the invention.

While the foregoing description sets forth various embodiments in accordance with aspects of the present invention, ordinarily skilled artisans will appreciate that other embodiments within the scope and spirit of the invention are intended to be encompassed herein. Accordingly, the invention should be considered as limited only by the scope of the following claims.

What is claimed is:

1. A blockchain-based system to effect accelerated foreign exchange (FX) transaction processing, wherein the blockchain-based system disaggregates funding of an FX transaction from the FX transaction itself by prequalifying the funding in a secure and trusted manner, the blockchain-based system including structure to effect the following:
responsive to a first indication from a first party (taker) of a desire to enter into a FX transaction, record the first indication in encrypted fashion in the system, and provide a first approval to the taker to engage in the FX transaction in response to satisfaction of first predetermined criteria which are communicated in encrypted fashion within the blockchain-based system; and
responsive to a second indication from a second party (maker) of a desire to enter into the FX transaction, record the second indication in encrypted fashion in the blockchain-based system, and provide a second approval to the maker to engage in the FX transaction in response to satisfaction of second predetermined criteria which are communicated in encrypted fashion within the blockchain-based system; and
record, in encrypted and immutable fashion, all steps in effecting the FX transaction;
wherein the system further comprises:
a taker node to enable the taker to participate in the FX transaction by exchanging first tokens that are priced according to a first fiat currency, for second tokens that are priced according to a second fiat currency; and
a maker node to enable the maker to participate in the FX transaction by exchanging the second tokens that are priced according to the second fiat currency, for the first tokens that are priced according to the first fiat currency;
wherein a value of the first tokens fluctuates only according to fluctuations in an underlying value of the first fiat currency, and a value of the second tokens fluctuates only according to fluctuations in an underlying value of the second fiat currency.

2. A blockchain-based system according to claim 1 wherein one of the first and second predetermined criteria includes agreement from at least one lender to provide funds in one of the first and second fiat currencies to one of the taker and the maker to prequalify one of the taker and the maker to engage in the FX transaction, the system further comprising:
a lender oracle to facilitate communication of lender data, associated with the at least one lender, from outside the blockchain to inside the blockchain in a trusted manner;
a taker oracle to facilitate communication of taker data, associated with the taker, from outside the blockchain to inside the blockchain in a trusted manner; and
a maker oracle to facilitate communication of maker data, associated with the maker, from outside the blockchain to inside the blockchain in a trusted manner.

3. A blockchain-based system according to claim 2, wherein the first predetermined criteria include agreement from at least one first lender to provide a first required amount of funds in the first fiat currency, as at least some of the first tokens, to the taker to prequalify funding for the taker to engage in the FX transaction.

4. A blockchain-based system according to claim 3, wherein the first required amount of funds consists of all of the funds that the taker will use to engage in the FX transaction.

5. A blockchain-based system according to claim 4, wherein the second predetermined criteria include agreement from at least one second lender to provide a second required amount of funds in the second fiat currency, as at least some of the second tokens, to the maker to prequalify funding for the maker to engage in the FX transaction.

6. A blockchain-based system according to claim 5, wherein the second required amount of funds consists of all of the funds that the maker will use to engage in the FX transaction.

7. A blockchain-based system according to claim 6, wherein the at least one first lender and the at least one second lender are the same.

8. A blockchain-based system according to claim 1, further comprising apparatus to execute at least one smart contract, responsive to the satisfaction of the first and second predetermined criteria, to effect the FX transaction.

9. A blockchain-based system according to claim 1, further comprising a security system to provide encryption for the first and second predetermined criteria, and to enable encrypted recording of the steps of the FX transaction.

10. A system according to claim 9, wherein the security system comprises a key management server to manage private encryption keys, and a hardware security module to generate the private encryption keys to provide the encryption for the first and second predetermined criteria, and to enable the encrypted recording of the steps of the FX transaction.

11. A blockchain-based method employing a blockchain to effect accelerated foreign exchange (FX) transaction processing, wherein the blockchain-based method disaggregates funding of an FX transaction from the FX transaction itself by prequalifying the funding in a secure and trusted manner, the blockchain-based method comprising:
on the blockchain, responsive to a first indication from a first party (taker) of a desire to enter into a FX transaction, recording the first indication in encrypted fashion in the system, and providing a first approval to the taker to engage in the FX transaction in response to satisfaction of first predetermined criteria which are communicated in encrypted fashion; and
on the blockchain, responsive to a second indication from a second party (maker) of a desire to enter into the FX transaction, recording the second indication in encrypted fashion in the blockchain-based system, and providing a second approval to the maker to engage in the FX transaction in response to satisfaction of second predetermined criteria which are communicated in encrypted fashion; and
recording, on the blockchain, all steps in effecting the FX transaction;
wherein the method further comprises:
enabling the taker to participate in the FX transaction by exchanging first tokens that are priced according to a first fiat currency, for second tokens that are priced according to a second fiat currency; and
enabling the maker to participate in the FX transaction by exchanging the second tokens that are priced according to the second fiat currency, for the first tokens that are priced according to the first fiat currency;
wherein a value of the first tokens fluctuates only according to fluctuations in an underlying value of the first fiat currency, and a value of the second tokens fluctuates only according to fluctuations in an underlying value of the second fiat currency.

12. A blockchain-based method according to claim 11 wherein one of the first and second predetermined criteria includes agreement from at least one lender to provide funds in one of the first and second fiat currencies to one of the taker and the maker to prequalify one of the taker and the maker to engage in the FX transaction, the method further comprising:
facilitating communication of lender data, associated with the at least one lender, from outside the blockchain to inside the blockchain;
facilitating communication of taker data, associated with the taker, from outside the blockchain to inside the blockchain; and
facilitating communication of maker data, associated with the maker, from outside the blockchain to inside the blockchain.

13. A blockchain-based method according to claim 12 wherein the first predetermined criteria include agreement from at least one first lender to provide a first required amount of funds in the first fiat currency, as at least some of the first tokens, to the taker to prequalify funding for the taker to engage in the FX transaction.

14. A blockchain-based method according to claim 13 wherein the first required amount of funds consists of all of the funds that the taker will use to engage in the FX transaction.

15. A blockchain-based method according to claim 14 wherein the second predetermined criteria include agreement from at least one second lender to provide a second required amount of funds in the second fiat currency, as at least some of the second tokens, to the maker to prequalify funding for the maker to engage in the FX transaction.

16. A blockchain-based method according to claim 15 wherein the second required amount of funds consists of all of the funds that the maker will use to engage in the FX transaction.

17. A blockchain-based method according to claim 16 wherein the at least one first lender and the at least one second lender are the same.

18. A blockchain-based method according to claim 11, further comprising executing at least one smart contract, responsive to the satisfaction of the first and second predetermined criteria, to effect the FX transaction.

19. A blockchain-based method according to claim 11, further comprising encrypting the first and second predetermined criteria, and encrypting recording of the steps of the FX transaction.

20. A blockchain-based method according to claim 19, further comprising generating private encryption keys to provide the encryption for the first and second predetermined criteria, and to enable the encrypted recording of the steps of the FX transaction.
